(19) United States
(12) Patent Application Publication
(10) Pub. No.: US 2024/0270135 A1
(43) Pub. Date: Aug. 15, 2024

(54) CONVEYANCE SEAT

(71) Applicant: TS TECH CO., LTD., Asaka-shi, Saitama (JP)

(72) Inventors: Hiroaki WADA, Tochigi (JP); Hironori WATANABE, Tochigi (JP); Takahide AOKI, Tochigi (JP); Masaji OKADA, Tochigi (JP); Yukihiro WATANABE, Tochigi (JP)

(21) Appl. No.: 18/567,527

(22) PCT Filed: Jun. 3, 2022
(86) PCT No.: PCT/JP2022/022614

§ 371 Date: Dec. 6, 2023

Related U.S. Application Data
(60) Provisional application No. 63/273,270, filed on Oct. 29, 2021.

(30) Foreign Application Priority Data
Jun. 7, 2021 (JP) 2021-095395
Jun. 7, 2021 (JP) 2021-095396
Dec. 27, 2021 (JP) 2021-213361
Jan. 12, 2022 (JP) 2022-002670

(51) Int. Cl. B60N 2/68

(52) U.S. Cl. CPC B60N 2/68

(57) ABSTRACT

A conveyance seat includes a cushion frame. The cushion frame includes side frames disposed on right and left sides in a seat width direction, and a pan frame (connecting frame) connecting the right and left side frames. The side frames includes respective engagement protrusions (engaging portions) that engage with engagement recesses (engaged portions) provided in the pan frame, to position the pan frame. The engagement protrusions are formed to protrude toward an engagement recess side in a facing direction (up to down direction) in which the side frames and the pan frame face each other. The engagement recesses engage with the respective engagement protrusions by coming into contact with the respective engagement protrusions in an intersecting direction intersecting with the facing direction.

### TECHNICAL FIELD

The present invention relates to a conveyance seat, particularly to a conveyance seat including a cushion frame serving as a skeleton of a seat cushion.

### BACKGROUND ART

In the related art, as described in PATENT LITERATURE 1, a vehicle seat which includes a cushion frame and in which the cushion frame includes side frames disposed on right and left sides and a pan frame having a plate shape and installed on front portions of the right and left side frames in a bridging manner is known.

At this time, the pan frame having a plate shape is connected to the right and left side frames by fastening rivets (attachment bolts) in a state where both right and left end portions of the pan frame are in contact with upper surfaces of the right and left side frames.

### CITATION LIST

### Patent Literature

PATENT LITERATURE 1: JP 2019-93987 A

### SUMMARY OF INVENTION

### Technical Problem

By the way, in the vehicle seat as described in PATENT LITERATURE 1, there has been a demand for further streamlining the assembly work of a seat frame (particularly, the cushion frame).

For example, when the pan frame (the other frame) is connected to the right and left side frames (one frame), there has been a demand for reducing man-hours of the assembly work of both the frames by facilitating the position adjustment of the frames.

In addition, for example, there has been a demand for streamlining the assembly work by reducing the number of components of the seat frame.

The present invention has been made in view of the above-described problems, and an object of the present invention is to provide a conveyance seat that enables the assembly work of a seat frame serving as a skeleton to be streamlined.

In addition, another object of the present invention is to provide a conveyance seat that enables assembly work to be streamlined through a reduction in the number of components of a seat frame.

### Solution to Problem

The foregoing problems are solved by a conveyance seat of the present invention including: a seat frame serving as a skeleton. The seat frame includes side frames disposed on right and left sides in a seat width direction, and a connecting frame connecting the right and left side frames. The side frames include engaging portions that engage with respective engaged portions provided in the connecting frame, to position the connecting frame. One of the engaging portions and the engaged portions is formed to protrude toward the other of the engaging portions and the engaged portions in a facing direction in which the side frames and the connecting frame face each other. The other engages with the one by coming into contact with the one in an intersecting direction intersecting with the facing direction.

With the above-described configuration, the conveyance seat that enables the assembly work of the seat frame to be streamlined can be realized.

In more detail, by engaging the engaged portions of the connecting frame with the respective engaging portions of the side frames in the facing direction in which the side frames and the connecting frame face each other, the positioning of both the frames in the intersecting direction intersecting with the facing direction can be easily performed. In addition, since the positioning can be easily performed, the man-hours of the assembly work of both the frames can be reduced.

In this case, the one may be an engagement protrusion protruding toward the other side in the facing direction, and the other may be an engagement hole that engages with the engagement protrusion, or is an engagement recess recessed opposite to one side in the facing direction.

With the above-described configuration, the positioning of both the frames can be easily performed by the engagement protrusion and the engagement recess having a simple shape.

In this case, the engaging portions may come into contact with the respective engaged portions in the facing direction and the intersecting direction to position the connecting frame in the facing direction and the intersecting direction.

With the above-described configuration, both the frames can be positioned with higher accuracy.

In this case, the engaging portions may be formed at respective outer end portions of the side frames in the seat width direction. The engaged portions may be formed at respective outer end portions of the connecting frame in the seat width direction. The engaging portions and the engaged portions may be exposed to an outside of the seat frame in the seat width direction in the seat frame.

With the above-described configuration, the state of engagement between the engaging portions and the engaged portions can be easily checked during the assembly work of the seat frame. For that reason, the assembly work of the seat frame can be streamlined.

In this case, the connecting frame may be formed from a plate-shaped frame. The connecting frame may include a reinforcement portion formed as a protrusion or a recess on a surface of the connecting frame and extending in the seat width direction. The engaged portions may be formed on the surface of the connecting frame at positions avoiding the reinforcement portion.

With the above-described configuration, the connecting frame can be suitably reinforced.

In addition, with the above-described configuration, for example, when the engaged portions having a protruding shape are formed in the connecting frame, by forming the engaged portions in the connecting frame while avoiding the reinforcement portion having an uneven shape, the protrusion amount of the engaged portions in an up to down direction can be reduced. As a result, interference of the engaged portions with other components can be suppressed.

In this case, the side frames may be side frames extending in a seat front to rear direction. The connecting frame may be a pan frame installed on front portions of the right and left side frames in a bridging manner. The reinforcement portion may be formed as a reinforcement recess having a recessed shape. A hooking portion for hooking a seat component of the conveyance seat may be formed on an upper surface of a portion of the pan frame at which the reinforcement recess is formed. The engaged portions may be formed on the respective right and left sides in the seat width direction, and may be disposed at positions where the engaged portions interpose the reinforcement recess between the engaged portions in the seat width direction.

With the above-described configuration, the assembly rigidity of the seat component to the pan frame (hooking portion) can be increased. Incidentally, for example, a skin material can be assumed as the seat component, and a skin terminal portion of the skin material can be hooked onto the pan frame (hooking portion).

In addition, interference between the engaged portions and the seat component (for example, the skin terminal portion) can be suppressed.

In this case, the side frames may be side frames extending in a seat front to rear direction. The connecting frame may be a pan frame installed on front portions of the right and left side frames in a bridging manner. The side frames may include respective flange portions formed at upper end portions of the side frames and protruding from body portions of the side frames to one side in the seat width direction. The engaging portions may be formed on upper surfaces of the respective flange portions, and may engage with the respective engaged portions formed on a bottom surface of the pan frame in a state where the upper surfaces of the flange portions and the bottom surface of the pan frame are overlapped.

With the above-described configuration, the engaged portions of the pan frame can be engaged with the respective engaging portions of the side frames in the up to down direction. For that reason, the positioning of both the frames can be more easily performed.

In this case, the connecting frame may be connected to the side frames by fastening a plurality of attaching members on surfaces where the connecting frame and the side frames face each other. The engaging portions and the engaged portions may be each disposed between a first attaching member and a second attaching member in a seat front to rear direction.

With the above-described configuration, the positioning accuracy at the fastening positions of the first attaching member and the second attaching member can be increased. For that reason, the work of fastening the first attaching member and the second attaching member can be efficiently performed.

In this case, each of the engaging portions and the engaged portions may extend in the seat width direction, may extend further outward in the seat width direction than the first attaching member and the second attaching member, and may extend further inward in the seat width direction than the first attaching member and the second attaching member.

With the above-described configuration, the positioning accuracy in the front to rear direction and the up to down direction by the engaging portions and the engaged portions can be increased.

In addition, with the above-described configuration, the work of fastening the first attaching member and the second attaching member can be more efficiently performed.

In this case, the side frames may be side frames extending in a seat front to rear direction. The connecting frame may be a pan frame installed on front portions of the right and left side frames in a bridging manner. The pan frame may include a frame body portion that is long in the seat width direction, and right and left frame side wall portions protruding downward from both respective end portions of the frame body portion in the seat width direction. The frame side wall portions and the engaged portions may be formed in the pan frame at different positions in the seat front to rear direction.

With the above-described configuration, the rigidity of the pan frame can be increased by the frame side wall portions, and the positioning of the pan frame with respect to the side frames can be performed by the engaged portions. At this time, interference between the frame side wall portions and the engaged portions can also be avoided.

### Advantageous Effects of Invention

According to the present invention, the conveyance seat that enables the assembly work of the seat frame to be streamlined can be realized. In more detail, the positioning of both the frames can be easily performed. In addition, the man-hours of the assembly work of both the frames can be reduced.

In addition, according to the present invention, both the frames can be positioned with higher accuracy.

In addition, according to the present invention, the state of engagement between the engaging portions and the engaged portions can be easily checked during the assembly work of the seat frame.

In addition, according to the present invention, the connecting frame can be suitably reinforced.

In addition, according to the present invention, interference of the engaging portions and the engaged portions with other components can be suppressed.

In addition, according to the present invention, the assembly rigidity of the seat component to the pan frame (hooking portion) can be increased.

In addition, according to the present invention, the work of fastening the first attaching member and the second attaching member can be efficiently performed.

In addition, according to the present invention, the rigidity of the pan frame can be increased, and the positioning of the pan frame with respect to the side frames can be easily performed.

### BRIEF DESCRIPTION OF DRAWINGS

FIG. 1 is a perspective view of a conveyance seat of a first embodiment.

FIG. 2 is a perspective view of a seat frame serving as a skeleton of the conveyance seat.

FIG. 3 is a perspective view of a cushion frame, and is a view showing side frames and a pan frame.

FIG. 4 is an enlarged view of main parts of the cushion frame, and is a view showing an engagement protrusion and an engagement recess.

FIG. 5 is a side view of the cushion frame.

FIG. 6 is a top view of the cushion frame.

FIG. 7 is a cross-sectional view taken along line VII-VII of FIG. 6.

FIG. 8A is a view showing an engagement protrusion and an engagement recess of Modification Example 1.

FIG. 8B is a view showing an engagement protrusion and an engagement hole of Modification Example 2.

FIG. 8C is a view showing an engagement protrusion and an engagement hole of Modification Example 3.

FIG. 8D is a view showing an engagement protrusion and an engagement hole of Modification Example 4.

FIG. 9 is a perspective view of a conveyance seat of a second embodiment.

FIG. 10 is a perspective view of a seat frame.

FIG. 11 is a side view of the seat frame.

FIG. 12A is a cross-sectional view of a fastening structure.

FIG. 12B is a cross-sectional view of the fastening structure, and is a view showing a state where a fastening member is fastened.

FIG. 13A is a cross-sectional view of a fastening structure of a modification example.

FIG. 13B is a cross-sectional view of the fastening structure of the modification example, and is a view showing a state where a fastening member is fastened.

FIG. 14 is a perspective view of a reclining device and a periphery of the reclining device.

FIG. 15 is a cross-sectional view of the reclining device and the periphery of the reclining device, and a view describing a positional relationship between a connecting bracket, a cushion frame, a back side frame, and links.

FIG. 16 is a view showing a state where a pad material is placed on the cushion frame.

FIG. 17 is a perspective view of a conveyance seat of a third embodiment.

FIG. 18 is a perspective view of a seat frame.

FIG. 19 is a view of a cushion frame when viewed from above.

FIG. 20 is a cross-sectional view of a cushion frame taken along line XX-XX of FIG. 19.

FIG. 21 is a cross-sectional view of the cushion frame taken along line XXI-XXI of FIG. 19.

FIG. 22 is a perspective view of a conveyance seat of a fourth embodiment.

FIG. 23 is a perspective view of a seat frame.

FIG. 24 is a view of a back frame when viewed from the rear.

FIG. 25 is a view of the back frame when viewed from the front.

FIG. 26A is an end view taken along line A-A of FIG. 25.

FIG. 26B is an end view taken along line B-B of FIG. 25.

FIG. 26C is an end view taken along line C-C of FIG. 25.

FIG. 26D is an end view taken along line D-D of FIG. 25.

FIG. 27 is a perspective view of a conveyance seat of a fifth embodiment.

FIG. 28 is a perspective view of a seat frame.

FIG. 29 is a perspective view of a cushion frame, and is a view showing a side frame on a seat left side, a height link device, and a tilt link device.

FIG. 30 is a perspective view of the cushion frame, and is a view showing a side frame on a seat right side, the height link device, and the tilt link device.

FIG. 31 is a cross-sectional view of a front connecting frame, and is a view showing a state where the side frame on the seat left side, a height link, and a tilt link are held.

FIG. 32 is a cross-sectional view of a front connecting frame, and is a view showing a state where the side frame on the seat right side, a height link, and a tilt link are held.

### DESCRIPTION OF EMBODIMENTS

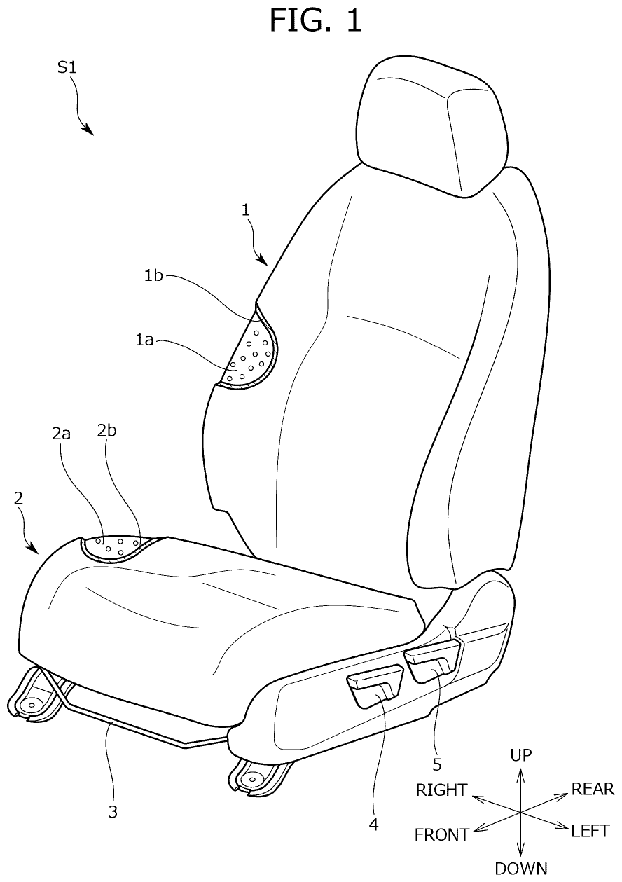

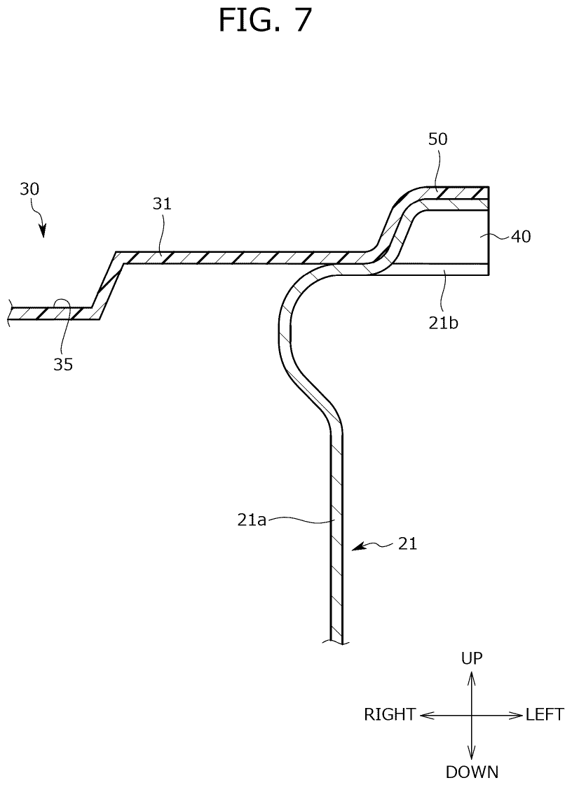

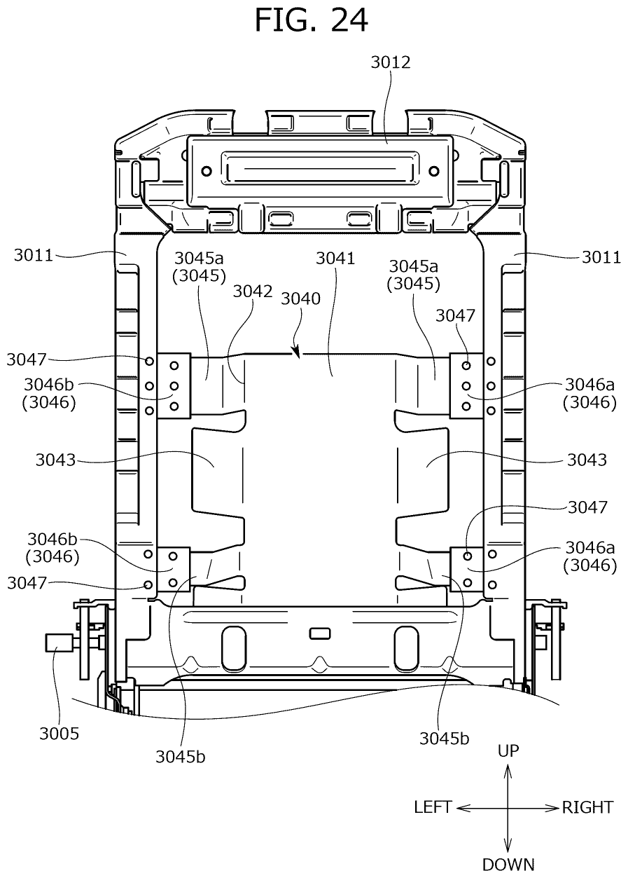

Hereinafter, embodiments according to the present invention will be described with reference to FIGS. 1 to 32.

Incidentally, a side on which a seated occupant is seated with respect to a seat back of a conveyance seat is a seat front side.

### First Embodiment

A conveyance seat S1 of a first embodiment will be described with reference to FIGS. 1 to 8D.

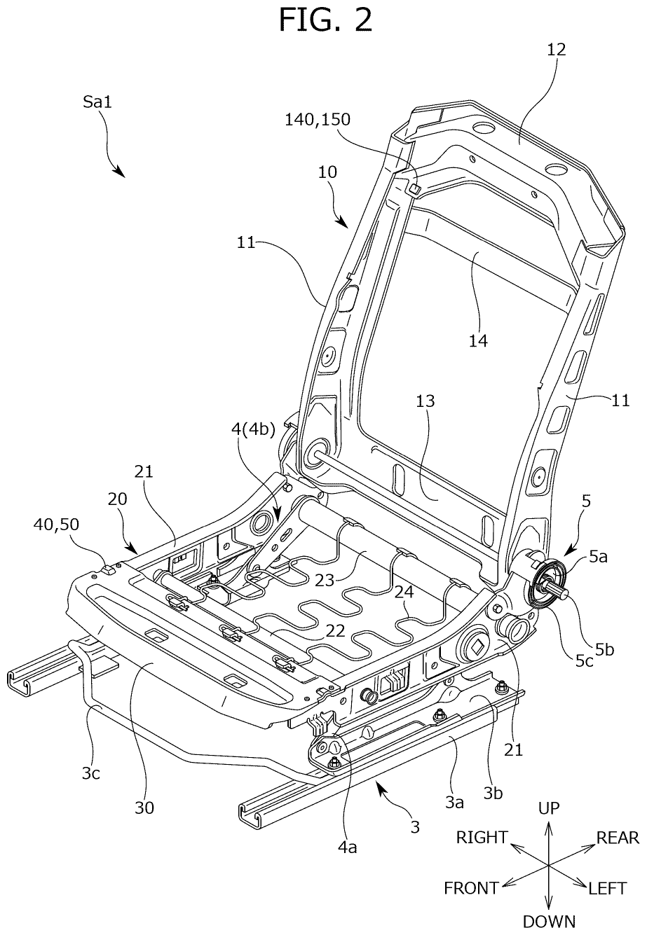

The conveyance seat S1 is a vehicle seat as shown in FIG. 1, and mainly includes a seat body including a seat back 1 and a seat cushion 2, and as shown in FIG. 2, a rail device 3 that supports the seat body so as to be movable forward and rearward with respect to a vehicle body floor, a height link device 4 that raisably and lowerably connects the seat body to the vehicle body floor, and a reclining device 5 that rotatably connects the seat back 1 to the seat cushion 2.

As shown in FIG. 1, the seat back 1 is a backrest portion that supports a seated occupant from the rear, and is configured by placing a pad material 1a on a back frame 10 serving as a skeleton shown in FIG. 2 and by covering the pad material 1a with a skin material 1b.

The seat cushion 2 is a seating portion that supports the seated occupant from below, and is configured by placing a pad material 2a on a cushion frame 20 serving as a skeleton shown in FIG. 2 and by covering the pad material 2a with a skin material 2b.

As shown in FIG. 2, the rail device 3 is disposed between the seat body and the vehicle body floor in an up to down direction, and mainly includes right and left lower rails 3a fixed to the vehicle body floor and extending in a seat front to rear direction; right and left upper rails 3b supported to be slidable along the lower rails 3a; a lock member (not shown) that non-slidably locks the upper rails 3b to the lower rails 3a; and a rail operating lever 3c for releasing a locked state of the lock member.

The cushion frame 20 is installed on upper surfaces of the right and left upper rails 3b via the height link device 4 in a bridging manner.

As shown in FIG. 2, the height link device 4 is attached between the rail device 3 and the cushion frame 20, and mainly includes right and left first links 4a disposed on a seat front side; right and left second links 4b disposed on a seat rear side; a lock member (not shown) that non-raisably and non-lowerably locks the seat body; and a height operating lever (not shown) for releasing a locked state of the lock member. Further, the height link device 4 is a device capable of adjusting the height of the seat body by using the second links 4b as drive links.

As shown in FIG. 2, the reclining device 5 mainly includes a reclining body 5a that is driven when the back frame 10 is rotated; a rotating shaft 5b; a spiral spring Sc that biases the back frame 10 to rotate forward about the rotating shafts 5b; and a reclining operating lever (not shown) that is operated to release a locked state of the back frame 10.

The reclining body 5a includes a known lock mechanism, and can switch the state of the back frame 10 between a locked state where the back frame 10 is fixed with respect to the cushion frame 20 and an unlocked state where the back frame 10 is rotatable with respect to the cushion frame 20.

The rotating shaft 5b is supported on a back frame 10 side and a cushion frame 20 side in a seat width direction, and the spiral spring Sc is configured such that one end portion of the spiral spring Sc is latched onto the back frame 10 side and the other end portion is latched onto the cushion frame 20 side.

As shown in FIG. 2, the back frame 10 is made of a substantially rectangular frame-shaped body, and mainly includes back side frames 11 disposed on the right and left sides; an upper frame 12 having an inverted U shape and connecting upper end portions of the back side frames 11; a lower frame 13 having a plate shape and connecting lower end portions of the back side frames 11; a member frame 14 connecting upper portions of the back side frames 11; and elastic springs (not shown) hooked onto each of the back side frames 11 and extending in a meandering manner.

The back side frames 11 are sheet metal members extending in the up to down direction and having a substantially C-shaped horizontal cross section, and the lower end portions of the back side frames 11 are connected to rear end portions of the side frames 21 via the reclining device 5.

As shown in FIG. 2, each of the back side frames 11 includes an engagement protrusion 140 that engages with an engagement recess 150 provided in the upper frame 12, to position the upper frame 12.

Incidentally, the back side frame 11 corresponds to a “side frame”, and the upper frame 12 corresponds to a “connecting frame”.

The engagement protrusion 140 is formed to protrude toward an engagement recess 150 side (seat front side) in a facing direction (seat front to rear direction) in which the back side frame 11 and the upper frame 12 face each other.

The engagement recess 150 is formed to be recessed opposite to an engagement protrusion 140 side in the facing direction (to the seat front side). The engagement recess 150 engages with the engagement protrusion 140 by coming into contact with the engagement protrusion 140 in an intersecting direction (the up to down direction and the seat width direction) intersecting with the facing direction (seat front to rear direction).

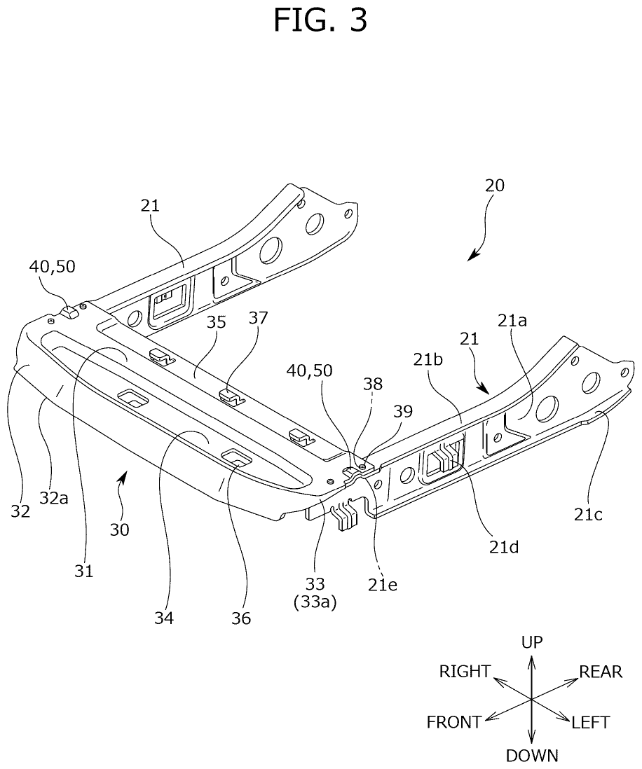

As shown in FIGS. 2 and 3, the cushion frame 20 is made of a substantially rectangular frame-shaped body, and mainly includes side frames 21 disposed on the right and left sides and extending in the seat front to rear direction; a pan frame 30 having a plate shape and installed on front end portions of the side frames 21 in a bridging manner; a front connecting frame 22 connecting front portions of the side frames 21; a rear connecting frame 23 connecting rear portions of the side frames 21; and a plurality of elastic springs 24 hooked onto the pan frame 30 and the rear connecting frame 23 and extending in a meandering manner in the seat front to rear direction.

As shown in FIGS. 3 to 7, each of the side frames 21 is a plate-shaped frame that is long in the seat front to rear direction, and includes a frame body portion 21a and an upper end flange portion 21b and a lower end flange portion 21c that bend and protrude outward from an upper end portion and a lower end portion of the frame body portion 21a in the seat width direction, respectively.

In addition, the side frame 21 includes a skin hooking portion 21d formed by cutting and raising a part of a side surface of the frame body portion 21a and used for hooking a terminal portion of the skin material 2b.

In addition, the side frame 21 has an attachment hole 21e (attachment portion) formed in an upper surface of the upper end flange portion 21b and used for attaching the pan frame 30.

A plurality of the skin hooking portions 21d and a plurality of the attachment holes 21e are formed at predetermined distances from each other in the seat front to rear direction.

Incidentally, the reclining device 5 is attached to the rear end portions of the side frames 21.

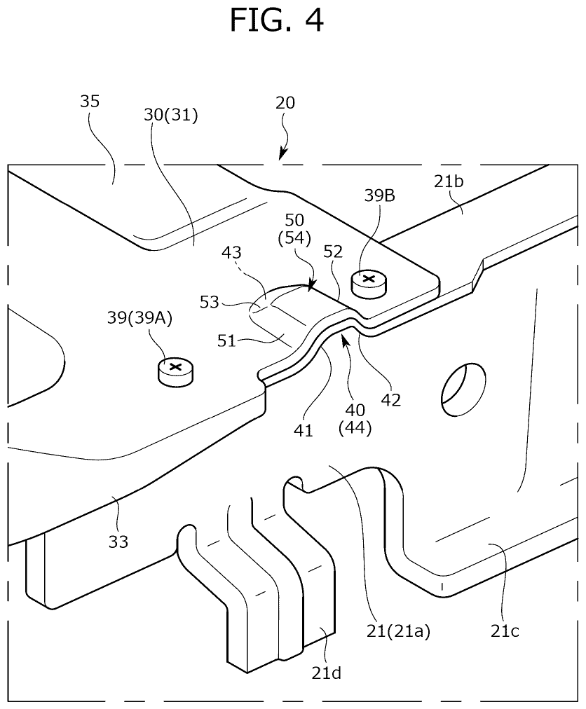

As shown in FIG. 4, the side frame 21 includes an engagement protrusion 40 that is formed on the upper surface of the upper end flange portion 21b, and that engages with an engagement recess 50 provided in the pan frame 30, to position the pan frame 30.

Incidentally, the side frame 21 corresponds to a “side frame”, and the pan frame 30 corresponds to a “connecting frame”.

As shown in FIG. 2, each of the front connecting frame 22 and the rear connecting frame 23 is a pipe-shaped frame, and connects the right and left side frames 21 and connects the right and left links (the first links 4a and the second links 4b).

The plurality of elastic springs 24 are elastic support members that support the buttocks of the seated occupant, and are provided at predetermined distances from each other in the seat width direction.

Front end portions of the elastic springs 24 are hooked onto spring hooking portions 37 formed on an upper surface of the pan frame 30. In addition, rear end portions of the elastic springs 24 are attached to the rear connecting frame 23 via hook members.

As shown in FIGS. 3 to 7, the pan frame 30 is a plate-shaped frame (connecting frame) installed on the upper surfaces of the right and left side frames 21 in a bridging manner and supporting the thighs of the seated occupant. Side portions of the pan frame 30 in the seat width direction are placed and attached to the upper surfaces of the side frames 21.

Specifically, the pan frame 30 mainly includes a frame body portion 31 having a rectangular plate shape that is long in the seat width direction; a frame front wall portion 32 protruding downward from a front end portion of the frame body portion 31; and right and left frame side wall portions 33 protruding downward from both right and left end portions of the frame body portion 31.

Incidentally, bent portions 32a and 33a are formed at tip portions of the frame front wall portion 32 and the frame side wall portions 33 by bending tips of the tip portions upward.

The bent portion 32a is continuously formed to extend along the seat width direction, and specifically, is formed by curling.

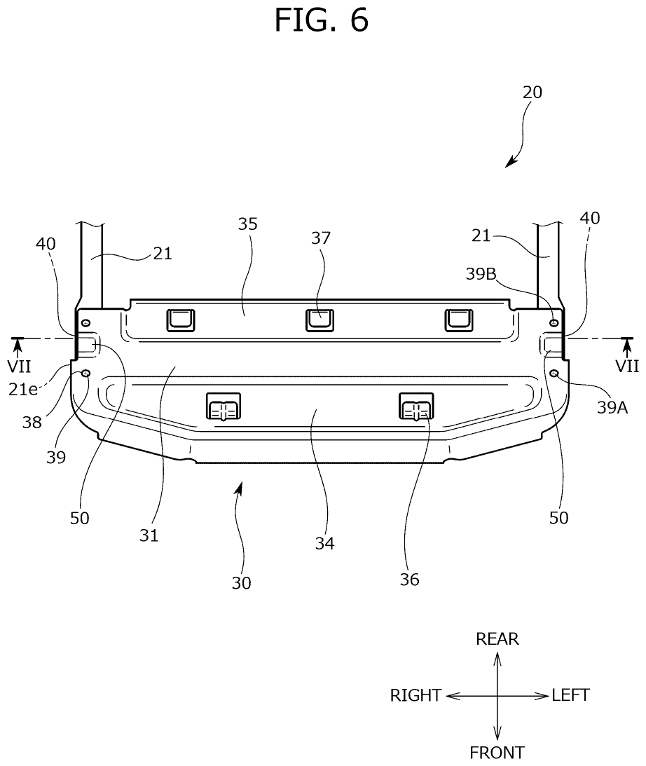

As shown in FIGS. 3 and 6, the pan frame 30 includes a first reinforcement recess 34 and a second reinforcement recess 35 formed as recesses on an upper surface of the frame body portion 31 and extending in the seat width direction.

Each of the first reinforcement recess 34 and the second reinforcement recess 35 is a substantially rectangular reinforcement portion that is long in the seat width direction, and the first reinforcement recess 34 is disposed at a seat front position with respect to the second reinforcement recess 35.

Skin hooking portions 36 for hooking the terminal portion of the skin material 2b are formed on an upper surface of the first reinforcement recess 34.

In addition, the spring hooking portions 37 for hooking one ends of the elastic springs 24 are formed on an upper surface of the second reinforcement recess 35.

A plurality of the skin hooking portions 36 are formed by cutting and raising parts of the upper surface of the first reinforcement recess 34, and are formed at distances from each other in the seat width direction.

A plurality of the spring hooking portions 37 are formed by cutting and raising parts of the upper surface of the second reinforcement recess 35, and are formed at predetermined distances from each other in the seat width direction.

The skin hooking portions 36 and the spring hooking portions 37 are disposed at different positions in the seat width direction.

As shown in FIGS. 3 to 5, the pan frame 30 includes right and left attachment holes 38 formed at both respective end portions of the frame body portion 31 in the seat width direction and used for attaching the right and left side frames 21.

By fastening attachment bolts 39 in a state where the attachment holes 38 of the pan frame 30 and the attachment holes 21e of the side frames 21 communicate with each other, the pan frame 30 is assembled to the side frames 21.

A plurality of the right attachment holes 38 and a plurality of the left attachment holes 38 are formed at distances from each other in the seat front to rear direction. In the present embodiment, two right attachment holes 38 and two left attachment holes 38 are formed.

The pan frame 30 includes the engagement recesses 50 that are formed at both end portions of the frame body portion 31 in the seat width direction, and that engage with the engagement protrusions 40 provided on the side frames 21.

### <<Details of Engagement Protrusion and Engagement Recess>>

As shown in FIGS. 3 to 7, the engagement protrusion 40 is formed to protrude toward an engagement recess 50 side (upper side) in a facing direction (up to down direction) in which the side frame 21 and the pan frame 30 face each other.

The engagement recess 50 is formed to be recessed opposite to an engagement protrusion 40 side in the up to down direction (to the upper side).

Incidentally, since the engagement protrusion 140 and the engagement recess 150 have the same configuration as the engagement protrusion 40 and the engagement recess 50, the description thereof will be omitted.

Specifically, each of the engagement protrusion 40 and the engagement recess 50 has a substantially semi-elliptical horizontal cross section and a substantially fan-shaped vertical cross section, and is formed to be curved.

As shown in FIG. 4, the engagement protrusion 40 includes a front wall portion 41, a rear wall portion 42, and a side wall portion 43 protruding upward from the upper surface of the side frame 21, and an upper wall portion 44 connecting respective upper end portions of the front wall portion 41, the rear wall portion 42, and the side wall portion 43.

The engagement recess 50 includes a front wall portion 51, a rear wall portion 52, and a side wall portion 53 protruding upward from the surface of the pan frame 30, and an upper wall portion 54 connecting respective upper end portions of the front wall portion 51, the rear wall portion 52, and the side wall portion 53.

The engagement protrusion 40 engages with the engagement recess 50 formed on a bottom surface of the pan frame 30 in a state where the upper surface of the upper end flange portion 21b and the bottom surface of the pan frame 30 are overlapped.

Further, the engagement protrusion 40 comes into contact with (abuts) the engagement recess 50 in the up to down direction, the seat front to rear direction, and the seat width direction to position the pan frame 30.

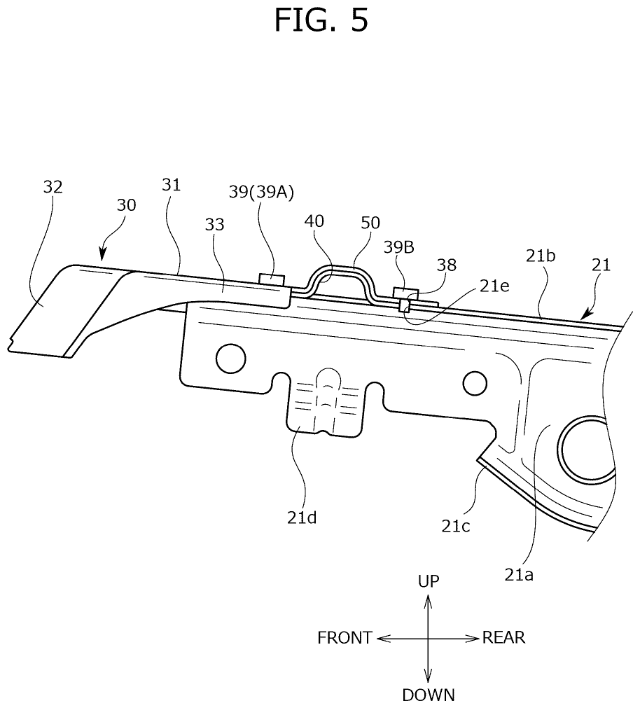

In the above-described configuration, as shown in FIGS. 4 and 5, the engagement protrusion 40 is formed at an outer end portion of the side frame 21 in the seat width direction, and the engagement recess 50 is formed at an outer end portion of the pan frame 30 in the seat width direction.

Namely, the engagement protrusion 40 and the engagement recess 50 are exposed to the outside of the cushion frame 20 in the seat width direction.

Consequently, the state of engagement between the engagement protrusion 40 and the engagement recess 50 can be easily checked during the assembly work of a seat frame Sa1. Further, the assembly work of the seat frame Sa1 can be streamlined.

In the above-described configuration, as shown in FIG. 6, the engagement recesses 50 are formed on the surface of the pan frame 30 at positions avoiding the first reinforcement recess 34 and the second reinforcement recess 35.

Consequently, the pan frame 30 can be suitably reinforced.

In addition, the protrusion amount of the engagement recesses 50 in the up to down direction can be reduced by forming the engagement recesses 50 in the pan frame 30 while avoiding the reinforcement recesses 34 and 35 having an uneven shape. As a result, interference of the engagement recesses with other components can be suppressed.

In the above-described configuration, as shown in FIG. 6, the skin hooking portions 36 are formed on the upper surface of the first reinforcement recess 34 in the pan frame 30. In addition, the spring hooking portions 37 are formed on the upper surface of the second reinforcement recess 35.

Further, the engagement recesses 50 are formed on the respective right and left sides in the seat width direction, and are disposed at positions where the engagement recesses 50 interpose the reinforcement recesses 34 and 35 therebetween in the seat width direction.

Consequently, interference between the engagement recesses 50 and seat components (specifically, the skin material 2b and the elastic springs 24) can be suppressed while increasing the rigidity of the pan frame 30.

In the above-described configuration, as shown in FIG. 6, each of the engagement protrusion 40 and the engagement recess 50 is disposed between a first attachment bolt 39A and a second attachment bolt 39B in the seat front to rear direction.

In addition, each of the engagement protrusion 40 and the engagement recess 50 extends for a long distance along the seat width direction. Specifically, each of the engagement protrusion 40 and the engagement recess 50 extends further outward in the seat width direction than the attachment bolts 39A and 39B, and extends further inward in the seat width direction than the attachment bolts 39A and 39B, respectively.

Consequently, the positioning accuracy of the attachment bolts 39A and 39B is increased. For that reason, the work of fastening the attachment bolts 39A and 39B can be efficiently performed.

In the above-described configuration, as shown in FIG. 5, the frame side wall portions 33 and the engagement recesses 50 are formed in the pan frame 30 at different positions in the seat front to rear direction.

In addition, the frame side wall portions 33 protrude downward, and the engagement recesses 50 protrude upward.

Consequently, while the rigidity of the pan frame 30 is increased by the frame side wall portions 33, the positioning of the pan frame 30 with respect to the side frames 21 can be performed by the engagement recesses 50. At this time, interference between the frame side wall portions 33 and the engagement recesses 50 can be avoided.

### <<Modification Examples 1 to 4 of Cushion Frame>>

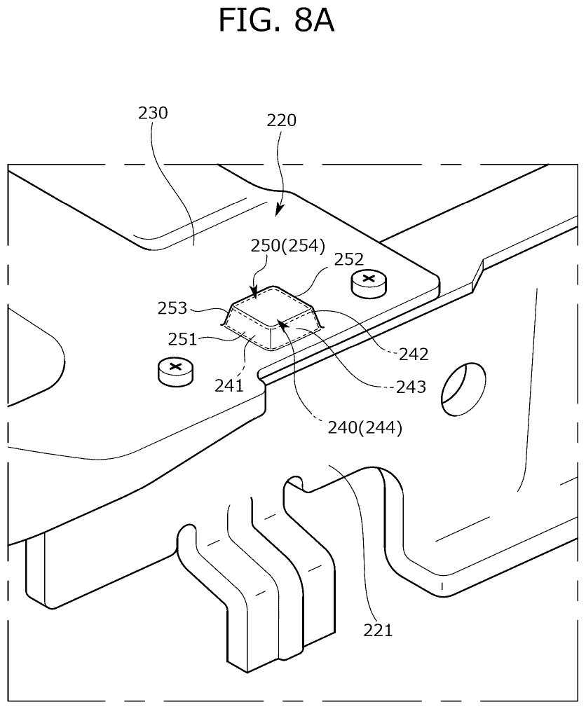

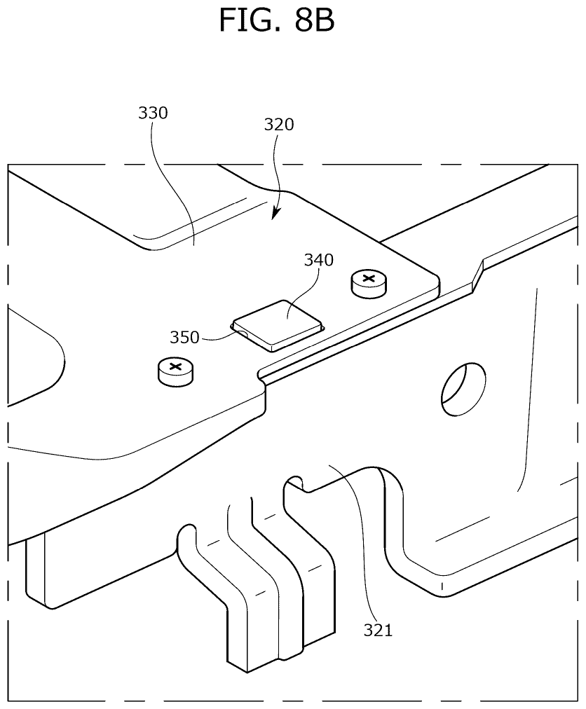

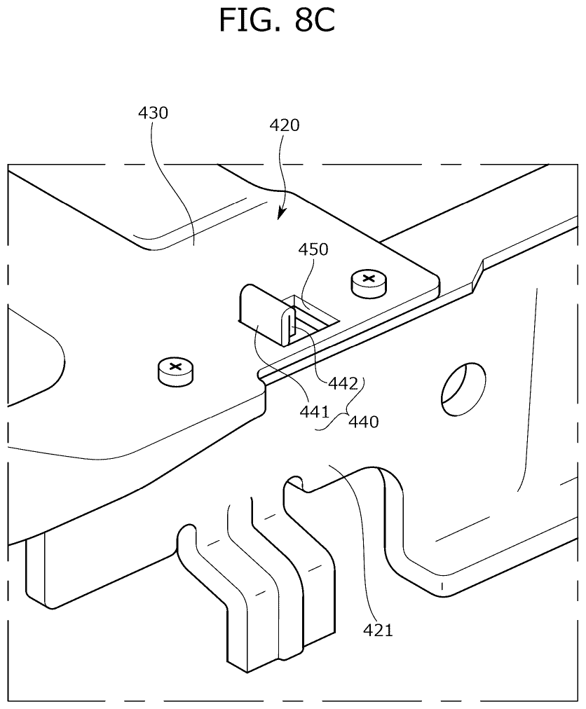

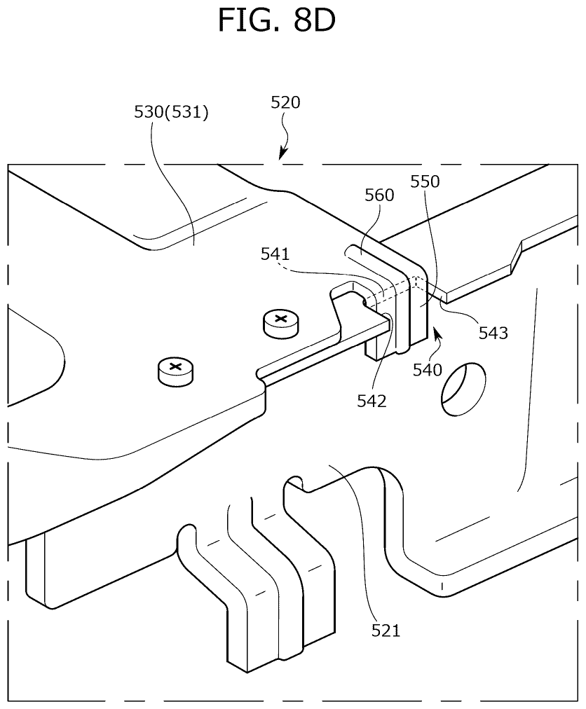

Next, Modification Examples 1 to 4 of the cushion frame will be described with reference to FIGS. 8A to 8D.

Incidentally, the description of contents that overlap with those of the cushion frame 20 described above will be omitted.

In a cushion frame 220 of Modification Example 1, as shown in FIG. 8A, a side frame 221 includes an engagement protrusion 240, and a pan frame 230 includes an engagement recess 250.

The engagement protrusion 240 is a substantially rectangular protrusion protruding from the side frame 221 toward an engagement recess 250 side.

The engagement recess 250 is a substantially rectangular recess formed to be recessed opposite to an engagement protrusion 240 side in the up to down direction (to the upper side).

The engagement protrusion 240 and the engagement recess 250 are formed, for example, by press forming.

Specifically, the engagement protrusion 240 includes a front wall portion 241, a rear wall portion 242, and right and left side wall portions 243 protruding upward from an upper surface of the side frame 221, and an upper wall portion 244.

Similarly, the engagement recess 250 also includes a front wall portion 251, a rear wall portion 252, right and left side wall portions 253, and an upper wall portion 254.

Namely, the engagement protrusion 240 and the engagement recess 250 are in contact with each other in four directions, namely, in the seat front to rear direction and a seat right to left direction.

Even with the above-described configuration, the conveyance seat S1 enables the assembly work of the seat frame Sa1 to be streamlined. Particularly, the positioning accuracy of both frames can be improved, and the positioning of both the frames can be easily performed.

In a cushion frame 320 of Modification Example 2, as shown in FIG. 8B, a side frame 321 includes an engagement protrusion 340, and a pan frame 330 includes an engagement hole 350.

The engagement protrusion 340 is a substantially rectangular protrusion protruding from the side frame 321 toward an engagement hole 350 side in the up to down direction.

The engagement hole 350 is a substantially rectangular through-hole penetrating in the up to down direction.

The engagement protrusion 340 penetrates through the engagement hole 350 to protrude further upward than the engagement hole 350, and is in contact with an edge portion of the engagement hole 350 over substantially the entire circumference.

Even with the above-described configuration, the conveyance seat S1 enables the assembly work of the seat frame Sa1 to be streamlined. Namely, the positioning of both frames can be easily performed.

In a cushion frame 420 of Modification Example 3, as shown in FIG. 8C, a side frame 421 includes an engagement protrusion 440, and a pan frame 430 includes an engagement hole 450.

The engagement protrusion 440 is a rectangular plate-shaped cut-and-raised portion formed by cutting out a part of an upper surface of the side frame 421.

Specifically, the engagement protrusion 440 includes a cut-and-raised portion 441 protruding upward, and a folded-back portion 442 formed by folding back a tip portion of the cut-and-raised portion 441.

The engagement hole 450 is a substantially rectangular through-hole penetrating in the up to down direction.

The engagement protrusion 440 penetrates through the engagement hole 450 to protrude further upward than the engagement hole 450, and is in contact with an edge portion of the engagement hole 450.

In more detail, the engagement protrusion 440 is in contact with a front edge portion, a left edge portion, and a right edge portion of the entire edge portion of the engagement hole 450.

Even with the above-described configuration, the conveyance seat S1 enables the assembly work of the seat frame Sa1 to be streamlined. Namely, the positioning of both frames can be easily performed.

In a cushion frame 520 of Modification Example 4, as shown in FIG. 8D, a side frame 521 includes an engagement cut portion 540, and a pan frame 530 includes an engagement bent portion 550.

The engagement cut portion 540 is a substantially rectangular cut portion formed by cutting out a part of an outer end portion of an upper surface of the side frame 521.

The engagement bent portion 550 is a bent portion (curved portion) formed by bending a part of an outer end portion of the pan frame 530 downward.

Incidentally, the pan frame 530 includes a reinforcement bead 560 formed in a protrusion shape from the frame body portion 531 to the engagement bent portion 550.

The engagement bent portion 550 is positioned by coming into contact with a bottom wall portion 541 and front and rear side wall portions 542 and 543 of the engagement cut portion 540. Namely, the pan frame 530 is positioned with respect to the side frame 521 in the front to rear direction and the right to left direction.

Even with the above-described configuration, the conveyance seat S1 enables the assembly work of the seat frame Sa1 to be streamlined. Namely, the positioning of both frames can be easily performed.

### <<Others>>

In the embodiment, as shown in FIGS. 2 and 3, in the cushion frame 20, the cushion side frame 21 and the pan frame 30 have been described as corresponding to a “side frame” and a “connecting frame”, respectively; however, such correspondence is not particularly limited and can be changed.

For example, the front connecting frame 22 may correspond to a “connecting frame”. Namely, the front connecting frame 22 may include the engagement recesses 50.

In addition, for example, the rear connecting frame 23 may correspond to a “connecting frame”.

In the embodiment, as shown in FIG. 2, in the back frame 10, the back side frame 11 and the upper frame 12 have been described as corresponding to a “side frame” and a “connecting frame”, respectively; however, such correspondence is not particularly limited and can be changed.

For example, the lower frame 13 may correspond to a “connecting frame”. Namely, the lower frame 13 may include the engagement recesses 150.

In addition, for example, the member frame 14 may correspond to a “connecting frame”.

In the embodiment, as shown in FIG. 4, the side frame 21 includes the engagement protrusion 40, and the pan frame 30 includes the engagement recess 50; however, such a configuration is not particularly limited and can be changed.

Conversely, the side frame 21 may include the engagement recess 50, and the pan frame 30 may include the engagement protrusion 40.

In the embodiment, as shown in FIG. 4, the engagement protrusion 40 is in contact with the engagement recess 50 in four directions, namely, in the seat front to rear direction and the seat width; however, such a configuration is not particularly limited and can be changed.

For example, the engagement protrusion 40 may come into contact with the engagement recess 50 in the seat front to rear direction, or may come into contact with the engagement recess 50 in the seat width direction. Namely, the engagement protrusion 40 may be in contact with the engagement recess 50 in at least one of the four directions of front, rear, right, and left.

Incidentally, it is preferable that the engagement protrusion 40 is in contact with the engagement recess 50 in the seat front to rear direction, the seat width direction, and the up to down direction. Consequently, the positioning accuracy by the engagement protrusion 40 and the engagement recess 50 can be further increased.

In the embodiment, as shown in FIG. 6, the engagement protrusions 40 and the engagement recesses 50 are disposed on each of the right and left sides in the seat width direction; however, such a configuration is not particularly limited and can be changed.

For example, the engagement protrusion 40 and the engagement recess 50 may be disposed only on one side in the seat width direction.

In the embodiment, as shown in FIGS. 4 and 8A to 8C, the engagement protrusions 40, 140, 240, 340, and 440 are formed by press forming or cutting and raising; however, such a method is not particularly limited and can be changed.

For example, the engagement protrusion 40 may be formed to protrude by attaching a separate frame piece to the upper surface of the cushion side frame 21.

In the embodiment, as shown in FIG. 6, the pan frame 30 includes the reinforcement recesses 34 and 35; however, the shape of the reinforcement portions is not particularly limited to a recessed shape, and can be changed.

For example, the pan frame 30 may include reinforcement protrusions formed as protrusions on the upper surface of the pan frame 30 and extending in the seat width direction.

### Second Embodiment

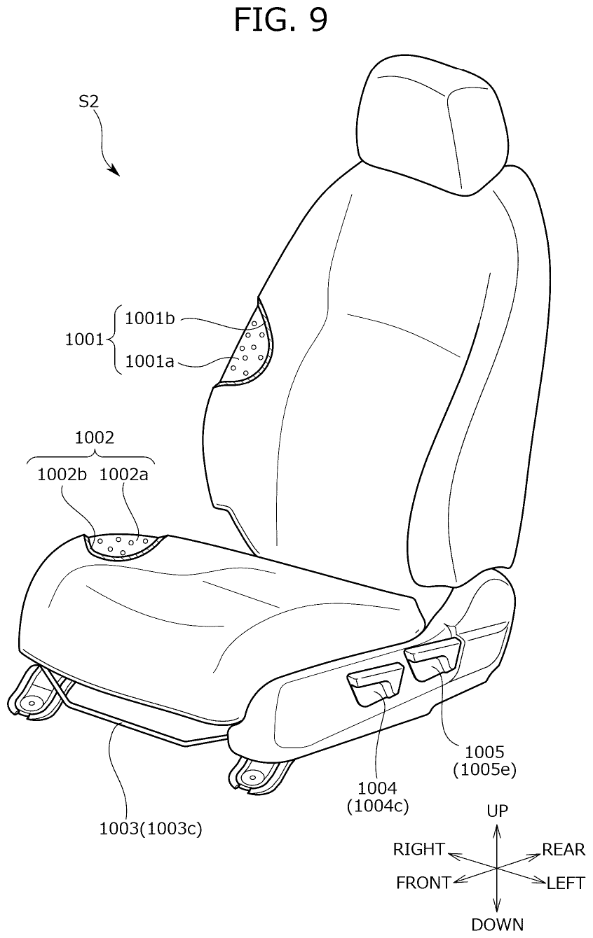

A conveyance seat S2 of a second embodiment will be described with reference to FIGS. 9 to 16.

Incidentally, the description of contents that overlap with those of the conveyance seat S1 described above will be omitted.

The conveyance seat S2 enables assembly work to be streamlined through a reduction in the number of components.

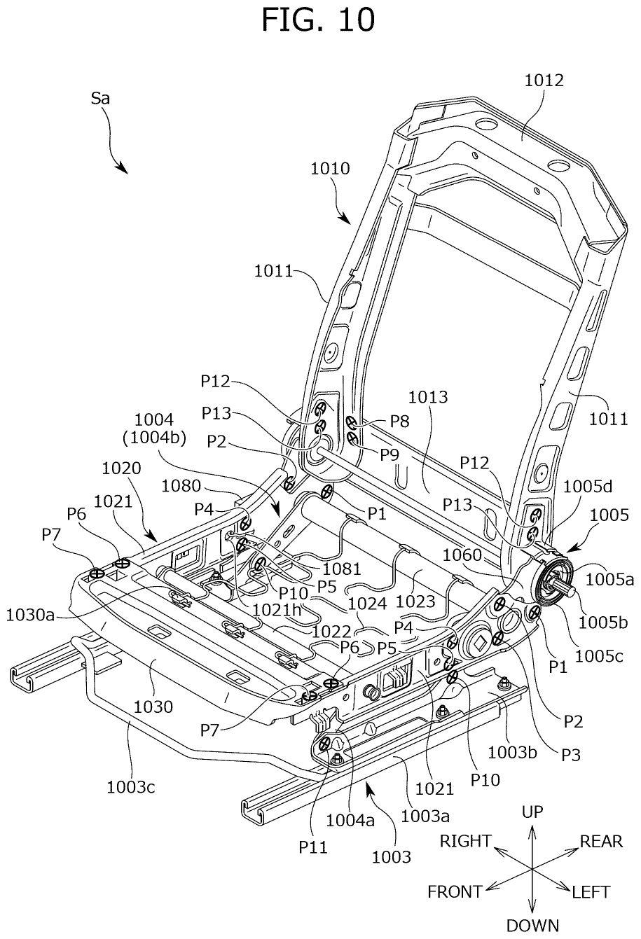

The conveyance seat S2 is a vehicle seat as shown in FIG. 9, and mainly includes a seat body including a seat back 1001 and a seat cushion 1002, and as shown in FIG. 10, a rail device 1003 that supports the seat body so as to be movable forward and rearward with respect to a vehicle body floor, a height link device 1004 that raisably and lowerably connects the seat body to the vehicle body floor, a reclining device 1005 that rotatably connects the seat back 1001 to the seat cushion 1002, connecting brackets 1060 connecting the seat cushion 1002 and the seat back 1001, and a drive device 1080 that drives a part of the conveyance seat.

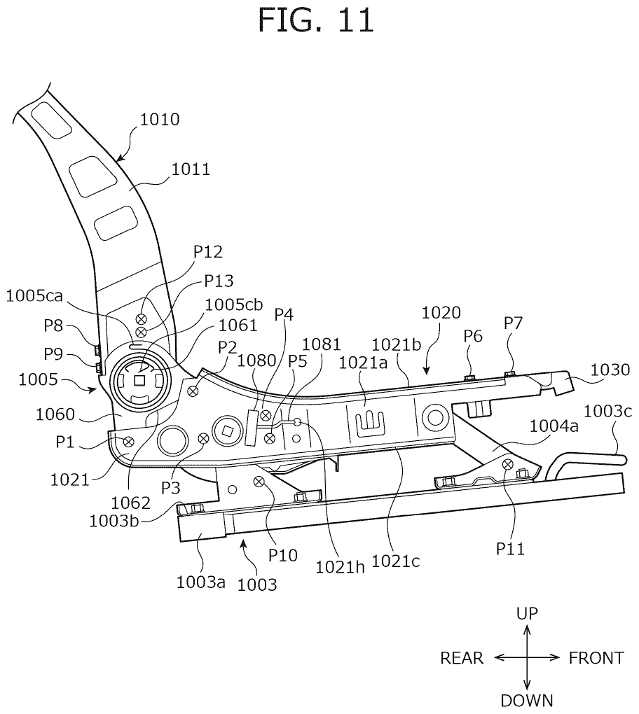

Incidentally, in FIGS. 10 and 11, fastening positions P1 to P13 indicate the fastening positions of screws 1070 that are fastening members, and are disposed right-left symmetrically with respect to a center line of the seat cushion 1002 in a seat width direction. Incidentally, in the present embodiment, each member is fastened at the fastening positions P1 to P13; however, the present invention is not limited thereto, and the fastening positions are one example and can be changed as appropriate.

As shown in FIG. 9, the seat back 1001 is a backrest portion that supports an occupant from the rear, and is configured by placing a pad material 1001a on a back frame 1010 serving as a skeleton shown in FIG. 10 and by covering the pad material 1001a with a skin material 1001b.

The seat cushion 1002 is a seating portion that supports the occupant from below, and is configured by placing a pad material 1002a on a cushion frame 1020 serving as a skeleton shown in FIG. 10 and by covering the pad material 1002a with a skin material 1002b.

A seat frame Sa2 includes the back frame 1010 and the cushion frame 1020. The back frame 1010 and the cushion frame 1020 are connected by the connecting brackets 1060.

As shown in FIG. 10, the cushion frame 1020 is made of a substantially rectangular frame-shaped body, and mainly includes cushion side frames 1021 disposed on the right and left sides; a pan frame 1030 having a plate shape and installed on front end portions of the cushion side frames 1021 in a bridging manner; a front connecting frame 1022 connecting front portions of the cushion side frames 1021; a rear connecting frame 1023 connecting rear portions of the cushion side frames 1021; and a plurality of elastic springs 1024 hooked onto the pan frame 1030 and the rear connecting frame 1023 and extending in a meandering manner in a seat front to rear direction.

The cushion side frames 1021 are plate-shaped frames that are long in the seat front to rear direction.

The reclining device 1005 is attached to the rear portions of the cushion side frames 1021 via the connecting brackets 1060, and the rail device 1003 is attached to lower portions of the cushion side frames 1021 via the height link device 1004. In addition, the drive device 1080 is attached to an outer surface of a central portion of the cushion side frame 1021 in the seat front to rear direction.

As shown in FIG. 11, each of the rear portion of each of the cushion side frames 1021 includes a body wall portion 1021a extending for a long distance in the seat front to rear direction, and an upper end flange 1021b and a lower end flange 1021c that are formed at an upper end portion and a lower end portion of the body wall portion 1021a, respectively, and that bend and protrude to one side (strictly speaking, the outside) in the seat width direction. The upper end flange 1021b and the lower end flange 1021c extend in the seat front to rear direction from a position where the reclining device 1005 is attached to the cushion side frame 1021 to a position where the pan frame 1030 is attached.

Further, the connecting bracket 1060 is assembled to an inner surface of the body wall portion 1021a in the seat width direction with the screws 1070. The cushion side frame 1021 and the connecting bracket 1060 are assembled with the screws 1070 at the fastening positions P1 and P2.

In addition, the drive device 1080 is assembled to an outer surface of the body wall portion 1021a in the seat width direction with the screws 1070. The cushion side frame 1021 and the drive device 1080 are assembled with the screws 1070 at the fastening positions P3, P4, and P5.

As shown in FIG. 10, the pan frame 1030 is a plate-shaped bridging frame that supports the thighs of the occupant, and side portions of the pan frame 1030 in the seat width direction are placed on upper surfaces of the cushion side frames 1021. The cushion side frames 1021 and the pan frame 1030 are assembled with the screws 1070 at the fastening positions P6 and P7.

Each of the front connecting frame 1022 and the rear connecting frame 1023 is a pipe-shaped frame, and connects the right and left cushion side frames 1021 and connects right and left links (first links 1004a and second links 1004b).

The plurality of elastic springs 1024 are elastic support members that support the buttocks of the occupant, and are provided at predetermined distances from each other in the seat width direction.

Front end portions of the elastic springs 1024 are hooked onto spring hooking portions 1030a formed on an upper surface of the pan frame 1030. In addition, rear end portions of the elastic springs 1024 are attached to the rear connecting frame 1023 via hook members.

As shown in FIG. 10, the back frame 1010 is made of a substantially rectangular frame-shaped body, and mainly includes back side frames 1011 disposed on the right and left sides; an upper frame 1012 having an inverted U shape and connecting upper end portions of the back side frames 1011; a lower frame 1013 having a plate shape and connecting lower end portions of the back side frames 1011; and elastic springs (not shown) hooked onto each of the back side frames 1011 and extending in a meandering manner.

The back side frames 1011 are sheet metal members extending in an up to down direction and having a substantially C-shaped horizontal cross section, and the lower end portions of the back side frames 1011 are connected to rear end portions of the cushion side frames 1021 via the reclining device 1005 and the connecting brackets 1060.

The lower frame 1013 is a plate-shaped sheet metal member extending in a right to left direction, and is connected to the lower end portion of each of the back side frames 1011. The back side frames 1011 and the lower frame 1013 are assembled with the screws 1070 at the fastening positions P8 and P9.

In the above-described configuration, the back frame 1010 is rotatable relative to the cushion frame 1020.

As shown in FIG. 10, the rail device 1003 is disposed between the seat body and the vehicle body floor in the up to down direction, and mainly includes right and left lower rails 1003a fixed to the vehicle body floor and extending in the seat front to rear direction; right and left upper rails 1003b supported to be slidable along the lower rails 1003a; a lock member (not shown) that non-slidably locks the upper rails 1003b to the lower rails 1003a; and a rail operating lever 1003c for releasing a locked state of the lock member.

The cushion frame 1020 is installed on upper surfaces of the right and left upper rails 1003b via the height link device 1004 in a bridging manner.

As shown in FIG. 10, the height link device 1004 is attached between the rail device 1003 and the cushion frame 1020, and mainly includes the right and left first links 1004a disposed on a seat front side; the right and left second links 1004b disposed on a seat rear side; a brake unit (not shown) that restricts a raising and lowering operation of the seat body; and a height operating lever 1004c (refer to FIG. 9) for releasing a restricted state of the brake unit.

When the height operating lever 1004c is operated, the second link 1004b (left second link) serves as a drive link, and the right second link 1004b and the right and left first links 1004a also rotate. Accordingly, the seat body is raised or lowered, so that the height of the seat is adjusted.

The rail device 1003 and the height link device 1004 are assembled with the screws 1070 at the fastening positions P10 and P11.

Incidentally, the height link device 1004 may be manually operated using the height operating lever 1004c, or may be automatically operated using the drive device 1080 to be described later that is driven by operating a button (not shown).

As shown in FIGS. 10 and 11, the reclining device 1005 is a device that rotatably connects the back frame 1010 to the cushion frame 1020, and that can lock the back frame 1010.

The reclining device 1005 mainly includes a reclining body 1005a that restricts the rotation of the back frame 1010; a rotating shaft 1005b that is supported on a lower end portion of the back frame 1010 in the seat width direction, and that protrudes from an outer surface of the back frame 1010 to be connected to the reclining body 1005a; and a spiral spring 1005c that is attached to an outer side of the reclining body 1005a in the seat width direction, and that biases the back frame 1010 to rotate about the rotating shaft 1005b to a cushion frame 1020 side.

The reclining body 1005a can switch the state of the back frame 1010 between a locked state where the back frame 1010 is fixed to the cushion frame 1020 and an unlocked state where the back frame 1010 is rotatable relative to the cushion frame 1020.

The reclining body 1005a is configured such that the state of the back frame 1010 is normally a locked state and that when a reclining operating lever 1005e shown in FIG. 9 is operated, the rotating shaft 1005b is rotated by the operation of the reclining operating lever 1005e and the state of the back frame 1010 is switched to an unlocked state.

Further, the reclining body 1005a is configured such that while the state of the back frame 1010 is in an unlocked state, the occupant can tilt the seat back 1001 rearward, and when the occupant releases the reclining operating lever 1005e at the time that the rearward tilt angle reaches a desired angle, the state of the back frame 1010 returns to a locked state.

Incidentally, the reclining body 1005a may be manually operated using the reclining operating lever 1005e, or may be automatically operated by the drive device 1080 that is driven by operating the button (not shown).

The rotating shaft 1005b is disposed between the right and left cushion side frames 1021 in a state where an axial direction of the rotating shaft 1005b is aligned along the seat width direction, and an extension end portion of the rotating shaft 1005b passes through a shaft hole (not shown), which is formed in a side surface of the back side frame 1011, to protrude outward in the seat width direction.

The extension end portion of the rotating shaft 1005b, which has protruded, is assembled to the reclining body 1005a, and is further assembled to the reclining operating lever 1005e shown in FIG. 9 located outside the reclining body 1005a.

When the state of the back frame 1010 is an unlocked state and the back frame 1010 is in a rearward tilted state, the spiral spring 1005c biases the back frame 1010 to rotate about the rotating shaft 1005b to the cushion frame 1020 side.

As shown in FIGS. 10 and 11, the spiral spring 1005c is configured such that one end portion 1005ca of the spiral spring 1005c is hooked onto a protruding portion of a spring latching bracket 1005d on a back side frame 1011 side. In addition, the spiral spring 1005c is configured such that the other end portion 1005cb of the spiral spring 1005c is hooked onto a spring latching portion 1061 of the connecting bracket 1060 on the cushion frame 1020 side.

The spring latching bracket 1005d is attached to an outer surface of the lower portion of the back side frame 1011. The reclining device 1005 is attached to the back frame 1010 via the spring latching bracket 1005d and the connecting bracket 1060. The back frame 1010 and the reclining device 1005 are assembled with the screws 1070 at the fastening positions P12 and P13.

As shown in FIGS. 10 and 11, the connecting brackets 1060 are metal plates connecting a rear portion of the cushion frame 1020 and a lower portion of the back frame 1010.

A central portion of the connecting bracket 1060 is fitted into an outer surface of the reclining body 1005a attached to the back side frame 1011.

In addition, a front portion and a lower portion of the connecting bracket 1060 are fastened to an inner surface of the cushion side frame 1021.

The spring latching portion 1061 protruding outward in the seat width direction and used for hooking the other end portion 1005cb of the spiral spring 1005c is formed at an upper portion of the connecting bracket 1060.

As shown in FIGS. 10 and 11, the drive device 1080 is attached to the outer surface of the central portion of the cushion side frame 1021 in the seat front to rear direction. The drive device 1080 is an electric motor that generates power according to the supply of electric power. The drive device 1080 rotates the first links 1004a and the second links 1004b around a horizontal axis with respect to the rail device 1003 according to the power of the drive device 1080, thereby causing the cushion side frames 1021 to move up and down.

Incidentally, the drive device 1080 may drive the rail device 1003 or the height link device 1004, or may drive other seat movable members. For example, the drive device 1080 may drive a blower device (not shown) disposed below the seat cushion 1002 to blow air toward the occupant seated in the seat, the reclining device 1005 described above, or the like.

### <<Flow Drilling Screw (FDS) Structure>>

A connection member 1081 is a wire harness formed by bundling a plurality of electric wires (transmission paths), and electrically connects the drive device 1080 and the height link device 1004. The connection member 1081 connected to the drive device 1080 is inserted from the outside of the cushion side frame 1021 in the seat width direction into the inside in the seat width direction through an insertion hole 1021h provided in the cushion side frame 1021. Further, the connection member 1081 extends along the inner surface of the cushion side frame 1021 and is connected to the height link device 1004.

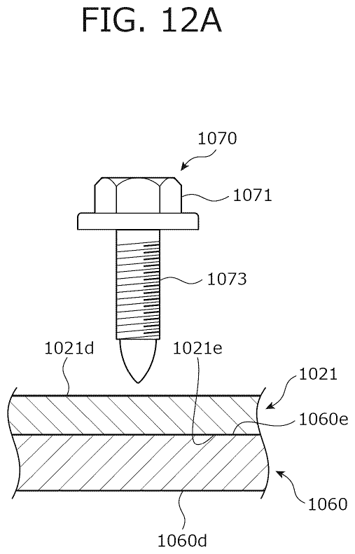

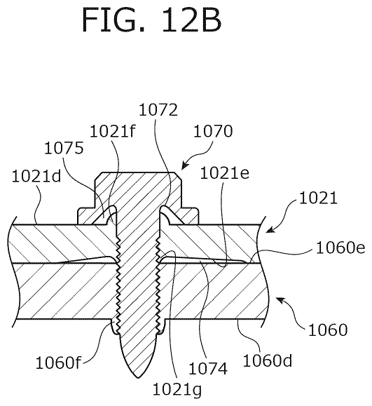

Here, a fastening structure and a fastening member of the present embodiment will be described with reference to FIG. 12.

As shown in FIG. 12A, the fastening structure of the present embodiment is a structure in which the cushion side frame 1021 as one example of a first frame member and the connecting bracket 1060 as one example of a second frame member are overlapped and fastened with the screws 1070. In the present embodiment, a thickness of a body portion of the cushion side frame 1021 is thinner than a thickness of a body portion of the connecting bracket 1060.

Incidentally, a surface of the cushion side frame 1021 on an insertion side in a fastening direction (penetrating direction) of the screws 1070 is referred to as a first surface 1021d, and a surface thereof opposite to the first surface 1021d and in contact with the connecting bracket 1060 is referred to as a first facing surface 1021e. Similarly, a surface of the connecting bracket 1060 on a penetration side in the fastening direction of the screws 1070 is referred to as a second surface 1060d, and a surface thereof opposite to the second surface 1060d and in contact with the cushion side frame 1021 is referred to as a second facing surface 1060e.

The fastening structure of the present embodiment is a flow drilling screw (FDS) structure in which fastened members (the cushion side frame 1021 and the connecting bracket 1060) are softened by high-speed rotation of the fastening members (screws 1070) and are pushed and joined together by axial pressure.

As shown in FIGS. 12A and 12B, the screw 1070 includes a screw head portion 1071 and a thread portion 1073, and a recessed portion 1072 recessed opposite to the thread portion 1073 is formed inside the screw head portion 1071. The recessed portion 1072 has an annular outer shape in a plan view. The material of the screw 1070 is, for example, metal such as steel, but is not limited thereto.

As shown in FIG. 12A, first, the cushion side frame 1021 and the connecting bracket 1060 are stacked in a state where the first facing surface 1021e of the cushion side frame 1021 and the second facing surface 1060e of the connecting bracket 1060 are overlapped. By rotating the screw 1070 from the first surface 1021d of the cushion side frame 1021 in a state where both are stacked, a hole is opened by frictional heat. The cushion side frame 1021 and the connecting bracket 1060 are fastened by being threaded.

As shown in FIG. 12B, after fastening, chips generated by the threading of the screw 1070 rise toward the insertion side in the fastening direction at a peripheral edge of a fastening portion of the first surface 1021d of the cushion side frame 1021, so that a first rising portion 1021f is formed on the cushion side frame 1021. The first rising portion 1021f fits into a screw head space portion 1075 within the recessed portion 1072 of the screw head portion 1071.

In addition, chips generated by threading rise toward the penetration side in the fastening direction at a peripheral edge of a fastening portion of the first facing surface 1021e of the cushion side frame 1021, so that a third rising portion 1021g is formed on the cushion side frame 1021. A space portion 1074 is formed between the first facing surface 1021e and the second facing surface 1060e by the third rising portion 1021g. Incidentally, the space portion 1074 may not be formed, and instead, the cushion side frame 1021 and the connecting bracket 1060 may be fastened without a gap therebetween.

Similarly, chips generated by the threading of the screw 1070 rise toward the penetration side in the fastening direction at a peripheral edge of a fastening portion of the second surface 1060d of the connecting bracket 1060, so that a second rising portion 1060f is formed on the connecting bracket 1060. Incidentally, although not shown, chips generated by threading may rise toward the insertion side in the fastening direction at a peripheral edge of a fastening portion of the second facing surface 1060e of the connecting bracket 1060, so that a rising portion is formed on a side opposite to the second rising portion 1060f.

The first rising portion 1021f, the second rising portion 1060f, and the third rising portion 1021g rise along the fastening direction of the screw 1070 at the peripheral edge portions of the respective portions of the cushion side frame 1021 and the connecting bracket 1060 where the screw 1070 is fastened. The cushion side frame 1021 or the connecting bracket 1060 comes into close contact with the thread portion 1073 due to the rising of chips generated by threading.

With such a fastening structure, the screw 1070 can be detachably joined to the cushion side frame 1021 or the connecting bracket 1060. In addition, the need for the work of drilling pilot holes can be eliminated. In addition, the joint strength of the fastened members can be increased. In addition, multilayer joining of fastened members even made of different materials can be realized. Further, with this fastening structure, automation becomes possible, so that work efficiency can be improved. In addition, no sparks or smoke are generated during fastening work, so that environmental pollution can be suppressed.

In addition, in the present embodiment, the screw 1070 penetrates from the cushion side frame 1021 having a thin thickness toward the connecting bracket 1060 having a thick thickness. Accordingly, since the connecting bracket 1060 having high strength is on the penetration side of the screw 1070, the screw 1070 can be more firmly fixed.

### <<Self-Piercing Riveting (SPR) Structure>>

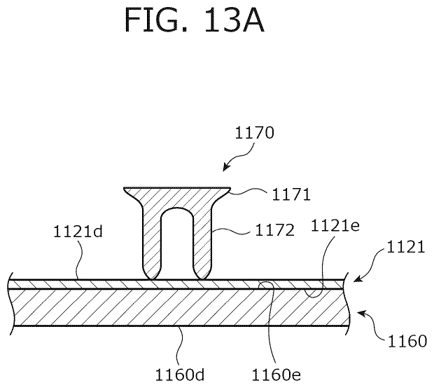

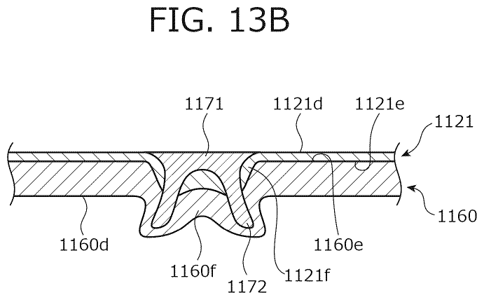

A modification example of the above-described fastening structure is shown in FIG. 13. This fastening structure is a self-piercing riveting (SPR) structure in which by pressing a fastening member (rivet 1170), an upper base material (cushion side frame 1121) and a lower base material (connecting bracket 1160) are joined with the upper base material penetrated but without the lower base material penetrated.

The rivet 1170 includes a rivet head portion 1171 having a disk shape and a rivet shaft portion 1172 having a cylindrical shape. A diameter of the rivet head portion 1171 is larger than an outer diameter of the rivet shaft portion 1172, but may be the same as the outer diameter of the rivet shaft portion 1172. The material of the rivet 1170 is, for example, metal such as steel, but is not limited thereto.

As shown in FIG. 13A, first, the cushion side frame 1121 and the connecting bracket 1160 are stacked in a state where a first facing surface 1121e of the cushion side frame 1121 and a second facing surface 1160e of the connecting bracket 1160 are overlapped. In a state where both are stacked, the rivet 1170 is driven into the cushion side frame 1121 by pressing the rivet head portion 1171 from a first surface 1121d of the cushion side frame 1121 using a general-purpose press device. As the driving operation progresses, the cushion side frame 1121 is plastically deformed to bulge toward a first facing surface 1121e side, and the connecting bracket 1160 is plastically deformed to bulge toward a second surface 1160d side. Further, when the driving operation progresses, the rivet shaft portion 1172 of the rivet 1170 starts to expand from a tip side, and cuts into the cushion side frame 1121.

As shown in FIG. 13B, the rivet 1170 penetrates through the cushion side frame 1121, but does not penetrate through the connecting bracket 1160. Joining is completed in a state where the rivet head portion 1171 is substantially flush with the first surface 1121d of the cushion side frame 1121. The rivet shaft portion 1172 expands to bite into the cushion side frame 1121 and the connecting bracket 1160. For that reason, both are firmly fixed due to the caulking effect.

After fastening, on the cushion side frame 1121, a first rising portion 1121f rising toward the penetration side in the fastening direction is formed at a peripheral edge of a fastening portion of the first facing surface 1121e of the cushion side frame 1121 by the rivet shaft portion 1172 of the rivet 1170.

Similarly, on the connecting bracket 1160, a second rising portion 1160f rising toward the penetration side (extrusion side) in the fastening direction (driving direction) is formed at a peripheral edge of a fastening portion (driving portion) of the second surface 1160d of the connecting bracket 1160 by the rivet shaft portion 1172.

The second rising portion 1160f has a curved cross section. For that reason, even when a worker or another member comes into contact with the second rising portion 1160f, the safety of the worker can be ensured, and damage to the other member can be suppressed.

The first rising portion 1121f and the second rising portion 1160f are formed at the peripheral edge portions of the respective portions of the cushion side frame 1121 and the connecting bracket 1160 where the rivet 1170 is driven, and rise along the driving direction of the rivet 1170.

With such a fastening structure, the rivet 1170 can be fastened to the cushion side frame 1121 and the connecting bracket 1160 while eliminating the need for the work of drilling pilot holes. In addition, the joint strength of the fastened members can be increased. In addition, multilayer joining of fastened members even made of different materials can be realized. Further, with this fastening structure, automation becomes possible, so that work efficiency can be improved. In addition, no sparks or smoke are generated during fastening work, so that environmental pollution can be suppressed.

Hereinafter, regarding the conveyance seat S2, each frame member using the fastening structure using the screw 1070 shown in FIG. 12 will be described with reference to FIGS. 10 and 14 to 16.

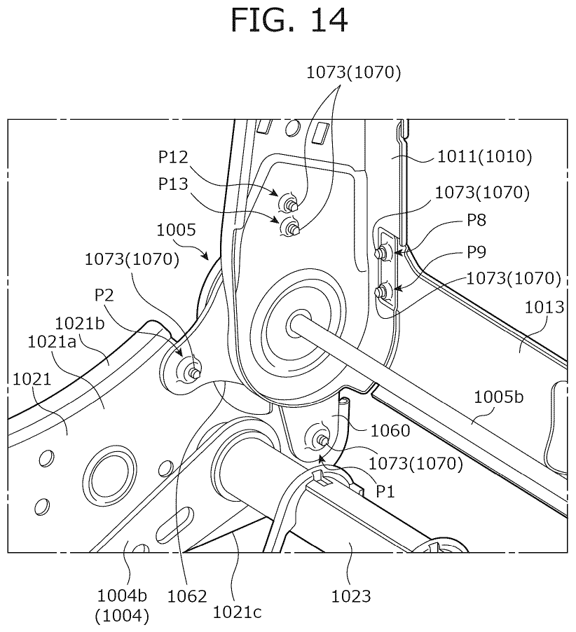

As shown in FIG. 14, at the fastening position P1, the lower portion of the connecting bracket 1060 and a rear lower portion of the body wall portion 1021a of the cushion side frame 1021 are overlapped such that the cushion side frame 1021 is on the outside in the seat width direction. In this state, the screw 1070 is fastened from the outside in the seat width direction. In addition, at the fastening position P2, the front portion of the connecting bracket 1060 and a rear upper portion of the body wall portion 1021a of the cushion side frame 1021 are overlapped such that the cushion side frame 1021 is on the outside in the seat width direction. In this state, the screw 1070 is fastened from the outside in the seat width direction.

With the above-described configuration, the connecting bracket 1060 can be efficiently assembled to the inner surface of the cushion side frame 1021. Specifically, the need for fastening nuts can be eliminated, the number of components can be reduced, and the work process can be shortened.

In addition, the connecting bracket 1060 is connected to the back side frame 1011 via the spring latching bracket 1005d inside the reclining device 1005 in the seat width direction. At this time, at the fastening positions P12 and P13, the spring latching bracket 1005d and the lower portion of the back side frame 1011 are overlapped such that the spring latching bracket 1005d is on the outside in the seat width direction. In this state, the screw 1070 is fastened from the outside in the seat width direction.

With the above-described configuration, the connecting bracket 1060 can be efficiently assembled to the outer surface of the back side frame 1011.

In addition, at the fastening positions P8 and P9, the seat rear side of the lower end portion of the back side frame 1011 and an end portion of the lower frame 1013 in the seat width direction are overlapped such that the back side frame 1011 is on the seat front side. In this state, the screws 1070 are fastened from the seat rear side.

With the above-described configuration, the lower frame 1013 can be efficiently assembled to a seat rear-side surface of the back side frame 1011.

Incidentally, as shown in FIG. 10, at the fastening positions P3, P4, and P5, the body wall portion 1021a of the cushion side frame 1021 and the drive device 1080 are overlapped such that the drive device 1080 is on the outside in the seat width direction. In this state, the screw 1070 is fastened from the outside in the seat width direction.

With the above-described configuration, the drive device 1080 can be efficiently assembled to an outer surface of the cushion side frame 1021 in the seat width direction.

In addition, at the fastening positions P6 and P7, the upper end flange 1021b of the cushion side frame 1021 and an end portion of the pan frame 1030 in the seat width direction are overlapped such that the pan frame 1030 is on a seat upper side. In this state, the screws 1070 are fastened from the seat upper side.

With the above-described configuration, the pan frame 1030 can be efficiently assembled to the seat upper-side surface of the cushion side frame 1021.

In addition, at the fastening position P10, a lower end portion of the second link 1004b of the height link device 1004 and the rail device 1003 are overlapped such that the second link 1004b is on the inside in the seat width direction. In this state, the screw 1070 is fastened from the inside in the seat width direction. In addition, at the fastening position P11, a lower end portion of the first link 1004a of the height link device 1004 and the rail device 1003 are overlapped such that the first link 1004a is on the inside in the seat width direction. In this state, the screw 1070 is fastened from the outside in the seat width direction.

With the above-described configuration, the rail device 1003 can be efficiently assembled to the height link device 1004.

Incidentally, the fastening directions of the screws 1070 at the fastening positions P1 to P13 in the present embodiment are not limited to the above-described directions, and the screws 1070 may penetrate from the opposite sides. For example, when the connecting bracket 1060 is assembled to the inner surface of the cushion side frame 1021, the screw 1070 may be fastened by penetrating from the connecting bracket 1060 toward the cushion side frame 1021. In addition, in the present embodiment, for example, the connecting bracket 1060 is assembled to the inner surface of the cushion side frame 1021; however, the present invention is not limited thereto, and the connecting bracket 1060 may be assembled to the outer surface of the cushion side frame 1021. Further, even in this case, the fastening direction may be set such that the screw 1070 penetrates from the outside in the seat width direction, or may be set such that the screw 1070 penetrates from the inside in the seat width direction.

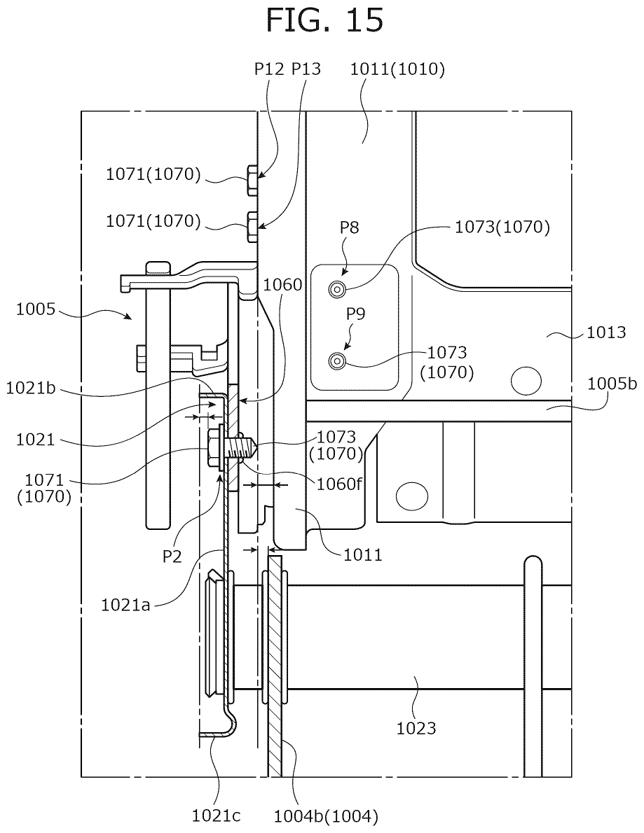

In the above-described configuration, as shown in FIG. 15, the screw 1070 located at the fastening position P2 fastens the connecting bracket 1060 and the cushion side frame 1021 from the outside in the seat width direction in a state where the cushion side frame 1021 is overlapped such that the cushion side frame 1021 is on the outside in the seat width direction. At this time, the screw 1070 and the second rising portion 1060f protrude further inward in the seat width direction than the body portion of the connecting bracket 1060. The screw 1070 and the second rising portion 1060f are disposed at a position that does not overlap the back side frame 1011 in the seat width direction.

For that reason, the connecting bracket 1060 can be compactly disposed in the seat width direction. In addition, when the back frame 1010 rotationally operates in the seat front to rear direction, interference between the connecting bracket 1060 (the screw 1070 and the second rising portion 1060f) and the back side frame 1011 can be suppressed.

In addition, in the above-described configuration, as shown in FIG. 15, a peripheral edge portion of the screw 1070 and the second link 1004b are disposed at different positions in the seat width direction.

For that reason, when the height link device 1004 operates, interference between the connecting bracket 1060 (the screw 1070 and the second rising portion 1060f) and the second link 1004b can be suppressed.

In addition, in the above-described configuration, as shown in FIG. 15, a peripheral edge portion of the screw head portion 1071 of the screw 1070 protrudes further outward in the seat width direction than the body wall portion 1021a in a space surrounded by the body wall portion 1021a, the upper end flange 1021b, and the lower end flange 1021c of the cushion side frame 1021. As described above, the first rising portion 1021f fits into the screw head space portion 1075 within the recessed portion 1072 of the screw head portion 1071 of the screw 1070. Namely, a protrusion height of the first rising portion 1021f is lower than protrusion heights of the upper end flange 1021b and the lower end flange 1021c.

Consequently, the screw head portion 1071 of the screw 1070 can be compactly disposed, and the interference of the screw 1070 with other members can be suppressed. In addition, since the first rising portion 1021f is lower than the protrusion heights of the upper end flange 1021b and the lower end flange 1021c, and is covered by the screw head portion 1071, damage to other members caused by the first rising portion 1021f can be suppressed.

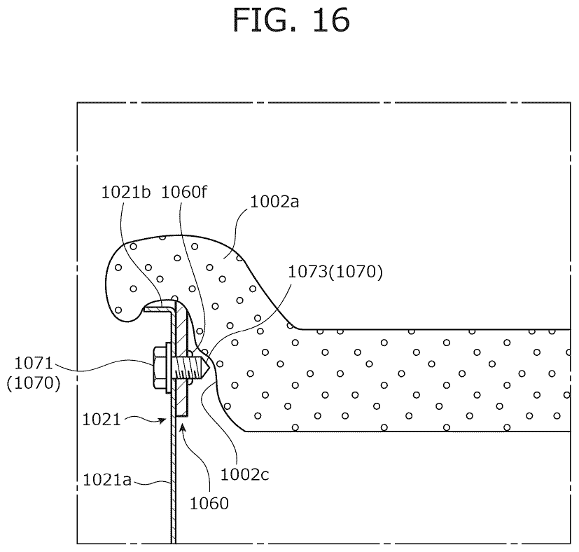

In addition, in the above-described configuration, as shown in FIG. 16, the screw 1070 located at the fastening position P2 fastens the connecting bracket 1060 and the cushion side frame 1021 in a state where the connecting bracket 1060 and the cushion side frame 1021 are overlapped such that the cushion side frame 1021 is on the outside in the seat width direction. In this state, the screw 1070 is fastened from the outside in the seat width direction. At this time, the screw 1070 and the second rising portion 1060f protrude further inward in the seat width direction than the body portion of the connecting bracket 1060.

The pad material 1002a is placed on the cushion side frame 1021 of the cushion frame 1020. A clearance portion 1002c is formed in the pad material 1002a at a position corresponding to a peripheral portion of the screw 1070 located at the fastening position P2. The clearance portion 1002c is formed in the pad material 1002a such that the screw 1070 and the second rising portion 1060f located at the fastening position P2 are located not to interfere with the pad material 1002a.

In such a manner, the screw 1070 and the second rising portion 1060f protruding further inward in the seat width direction than the body portion of the connecting bracket 1060 are disposed at a position that does not overlap the pad material 1002a in the seat width direction. For that reason, when the pad material 1002a is placed on the cushion side frame 1021, interference between the peripheral edge portion of the screw 1070 located at the fastening position P2 on the connecting bracket 1060 and the pad material 1002a can be suppressed.

Incidentally, the clearance portion 1002c may be formed in a recessed shape, or may be formed in a shape in which a portion of the pad material 1002a is missing. In addition, regarding a direction in which interference is avoided, interference may be avoided in the seat up to down direction or may be avoided in the seat width direction.

In addition, in the above-described configuration, as shown in FIGS. 10 and 11, the screws 1070 located at the fastening positions P4 and P5 fasten the drive device 1080 and the cushion side frame 1021 in a state where the drive device 1080 and the cushion side frame 1021 are overlapped such that the drive device 1080 is on the outside in the seat width direction. In this state, the screw 1070 is fastened from the outside in the seat width direction. At this time, the screws 1070 and the second rising portions 1060f protrude further inward in the seat width direction than the body portion of the cushion side frame 1021.

The connection member 1081 is inserted from the outside of the cushion side frame 1021 in the seat width direction into the inside in the seat width direction through the insertion hole 1021h provided in the cushion side frame 1021. The connection member 1081 extends along the inner surface of the cushion side frame 1021 and is connected to the height link device 1004. At this time, the connection member 1081 is disposed to avoid the positions corresponding to the peripheral portions of the screws 1070 located at the fastening positions P4 and P5.

In such a manner, the screws 1070 and the second rising portions 1060f protruding further inward in the seat width direction than the body portion of the cushion side frame 1021 are disposed at positions that do not overlap the connection member 1081 in the seat width direction. For that reason, when the connection member 1081 is disposed, interference between the peripheral edge portions of the screws 1070 located at the fastening positions P4 and P5 and the connection member 1081 can be suppressed.

Incidentally, this is not limited to the fastening positions P4 and P5, and the connection member 1081 is disposed to avoid the positions corresponding to the peripheral portions of the screws 1070 at the peripheral edge portions of the screws 1070 at the fastening positions in the vicinity of a place where the connection member 1081 is disposed.

In addition, in the above-described configuration, as shown in FIG. 14, a cutout portion 1062 cut out toward a side opposite to a rear connecting frame 1023 side is formed at a portion of an outer peripheral portion of the connecting bracket 1060, the portion being close to the rear connecting frame 1023.

For that reason, interference between the connecting bracket 1060 and the rear connecting frame 1023 can be suppressed.

Incidentally, the cutout portion 1062 is cut out in a substantially triangular shape, and is disposed to be interposed between two fastening positions P1 and P2.

In addition, in the above-described configuration, as shown in FIG. 14, the fastening position P2 is located at a seat front position with respect to the fastening position P1. The fastening position P1 is located to overlap the rear connecting frame 1023 in the seat front to rear direction, and is located to overlap the reclining body 1005a in the up to down direction. Further, the fastening position P2 is located to overlap the reclining body 1005a in the seat front to rear direction, and is located to overlap the rear connecting frame 1023 in the up to down direction.

For that reason, the assembly rigidity of the reclining body 1005a and the rear connecting frame 1023 can be increased.

### <<Others>>

In the embodiment, as shown in FIG. 10, the conveyance seat S2 includes the rail device 1003, the height link device 1004, and the reclining device 1005; however, the present invention is not particularly limited.

Namely, the conveyance seat S2 may not include the rail device 1003, the height link device 1004, and the reclining device 1005.

In addition, the height link device 1004 and the reclining device 1005 may be operated by driving the drive device 1080, or may be operated by manually operating the lever.

In the embodiment, as shown in FIGS. 10 and 11, at the fastening positions P1 to P13, the cushion side frames 1021, the pan frame 1030, the back side frames 1011, the lower frame 1013, the rail device 1003, the height link device 1004, the reclining device 1005, the connecting brackets 1060, and the drive device 1080 are each fastened by this fastening structure; however, the present invention is not particularly limited, and other seat frame members may be fastened. The other seat frame members include, for example, a height brake, a hook spring, a member frame, and the like.

Even in that case, the fastening direction (driving direction) of the rivet 1170 is not limited to the above-described direction, and the rivet 1170 may be driven from any direction of the fastened members.

In the embodiment, at the fastening positions P1 to P13, each frame member is fastened by the fastening structure using the screw 1070 shown in FIG. 12; however, the present invention is not particularly limited, and each frame member may be fastened by the fastening structure using the rivet 1170 shown in FIG. 13.

Even in that case, the fastening direction (driving direction) of the rivet 1170 is not limited to the above-described direction, and the rivet 1170 may be driven from any direction of the fastened members.

In the embodiment, as shown in FIGS. 12 and 13, fastening holes are not formed in the cushion side frame 1021 or the connecting bracket 1060 in advance; however, the present invention is not particularly limited. Fastening holes may be formed in the cushion side frame 1021 or the connecting bracket 1060 in advance.

In the embodiment, as shown in FIG. 15, the connecting bracket 1060 is attached to the inner surface of the cushion side frame 1021; however, the present invention is not particularly limited, and the connecting bracket 1060 may be attached to the outer surface of the cushion side frame 1021.

In that case, it is preferable that the cushion side frame 1021 has a stepped shape that is bent inward in the seat width direction.

In the embodiment, as shown in FIG. 15, the connecting bracket 1060 is attached to the outer surface of the back side frame 1011; however, the present invention is not particularly limited, and the connecting bracket 1060 may be attached to an inner surface of the back side frame 1011.

### <<Additional Notes>>

A conveyance seat S2 may include a seat frame serving as a skeleton. The seat frame may include a first frame member, a second frame member facing at least a part of the first frame member, and a fastening member driven into a portion where the first frame member and the second frame member face each other, to fasten the first frame member and the second frame member. The first frame member may include a first rising portion formed at a peripheral edge portion of a portion of the first frame member where the fastening member is fastened, and rising along a fastening direction of the frame member, and the second frame member may include a second rising portion formed at a peripheral edge portion of a portion of the second frame member where the fastening member is fastened, and rising along the fastening direction of the fastening member.

In addition, a method for manufacturing a conveyance seat S2 may include: a disposing step of disposing a first frame member and a second frame member facing at least a part of the first frame member; and a fastening step of driving a fastening member from a first frame member side into a second frame member side to fasten the first frame member and the second frame member. In the fastening step, a first rising portion rising along a fastening direction of the fastening member may be formed at a peripheral edge portion of a portion of the first frame member where the fastening member is fastened, and a second rising portion rising along the fastening direction of the fastening member may be formed at a peripheral edge portion of a portion of the second frame member where the fastening member is fastened.

With the above-described configuration, the conveyance seat that enables assembly work to be streamlined, specifically, a reduction in the number of components can be realized.

In more detail, the fastening member causes the first rising portion to be formed on the first frame member (for example, a cushion frame or a back frame), and causes the second rising portion to be formed on the second frame member (for example, a connecting bracket). For that reason, even when the first frame member is not threaded in advance, the peripheral edge portion of the portion where the fastening member is fastened rises along the fastening direction, and comes into contact with the fastening member, so that the first frame member and the second frame member are fixed.

Generally, the connecting bracket is fixed to the cushion frame or the back frame using a fastening bolt and a fastening nut; however, according to this configuration, the need for a fastening nut can be eliminated. In addition, a fastening hole for fastening the fastening member does not need to be provided to the connecting bracket or the cushion side frame in advance, and the need for the work of providing the fastening hole can also be eliminated. In addition, the fastening work using the fastening member can be automated.

Therefore, the conveyance seat that streamlines the assembly work of the connecting bracket (eliminating the need for a fastening nut, reducing the number of components, and shortening fastening work) can be realized.

In this case, the seat frame may include a cushion frame and a back frame. The first frame member may be the cushion frame or the back frame. The second frame member may be a connecting bracket connecting a seat rear portion of the cushion frame and a lower portion of the back frame.

With the above-described configuration, the conveyance seat that streamlines the assembly work of the frame members in the seat including the connecting bracket connecting the cushion frame and the back frame can be realized.

In this case, the conveyance seat may include a pad material placed on the first frame member. The second frame member may be disposed inside the first frame member in a seat width direction. At least one of the fastening member and the second rising portion may protrude further inward in the seat width direction than a body portion of the second frame member. The pad material may include a clearance portion formed at a position corresponding to the at least one so as to avoid interference with the at least one.

With the above-described configuration, since the pad material includes the clearance portion, the fastening member or the second rising portion is disposed at a position that does not overlap the pad material in the seat width direction. For that reason, when the pad material is disposed on the cushion frame or the back frame, interference between the connecting bracket (peripheral edge portion of the portion where the fastening member is fastened) and the pad material can be suppressed.

In this case, a reclining device that rotatably connects the back frame to the cushion frame may be provided. The reclining device may include a reclining body attached to an outer surface of the back frame to restrict a rotation of the back frame. The second frame member may be attached to the outer surface of the back frame and may be attached to an inner surface of the reclining body.

With the above-described configuration, in the seat including the reclining device having a complicated structure, the assembly work of the device can be streamlined by using this fastening structure.

In this case, the back frame may include back side frames disposed on right and left sides in a seat width direction. At least one of the fastening member and the second rising portion may protrude further inward in the seat width direction than a body portion of the second frame member, and may be disposed at a position that does not overlap the corresponding back side frame in the seat width direction.

With the above-described configuration, the fastening member or the second rising portion protruding further inward in the seat width direction than the body portion of the connecting bracket is disposed at the position that does not overlap the corresponding back side frame in the seat width direction. For that reason, when the back frame rotationally operates in a seat front to rear direction, interference between the connecting bracket (peripheral edge portion of the portion where the fastening member is fastened) and the back side frame can be suppressed.

In this case, a height link device that raisably and lowerably connects the cushion frame to a vehicle body floor may be provided. The height link device may include right and left links provided between the cushion frame and the vehicle body floor. At least one of the fastening member and the second rising portion may be disposed at a position that does not overlap the corresponding link in a seat width direction.

With the above-described configuration, the fastening member or the second rising portion is disposed at the position that does not overlap the corresponding link in the seat width direction. For that reason, when the height link device operates, interference between the connecting bracket (peripheral edge portion of the portion where the fastening member is fastened) and the corresponding link can be suppressed.

In this case, the first frame member may include flanges that are formed at end portions of the first frame member in an up to down direction and that bend and protrude outward in a seat width direction. The first rising portion may protrude further outward in the seat width direction than a body portion of the first frame member. A protrusion height of the first rising portion may be lower than a protrusion height of the flanges.

With the above-described configuration, for example, a protruding portion of the first rising portion fits into a space formed by a body portion, an upper end flange, and a lower end flange of the cushion frame. For that reason, the connecting bracket can be compactly disposed in the seat width direction.

In this case, the conveyance seat may include a drive device attached to the first frame member and driven to switch a part of the conveyance seat between a normal position and a movement position moved from the normal position; and a connection member connected to the drive device to supply an electric power toward the drive device, and extending along an inner surface of the first frame member. The second frame member may be disposed inside the first frame member in a seat width direction. At least one of the fastening member and the second rising portion may protrude further inward in the seat width direction than a body portion of the second frame member. The connection member may be disposed on the inner surface of the first frame member at a position different from a position of the at least one.

With the above-described configuration, the fastening member or the second rising portion is disposed at a position that does not overlap the connection member in the seat width direction. For that reason, when the connection member is disposed, interference between the connecting bracket (peripheral edge portion of the portion where the fastening member is fastened) and the connection member can be suppressed.

In this case, the first frame member and the second frame member may be plate-shaped members. The second frame member may be disposed inside the first frame member in a seat width direction. A thickness of the first frame member may be thinner than a thickness of the second frame member. The fastening member may be fastened to be driven from a first frame member side into a second frame member side.

With the above-described configuration, the fastening member is fastened from the first frame member having a thin thickness toward the second frame member having a thick thickness. For that reason, the second frame member having high strength is on a penetration side of the fastening member, so that the fastening member can be more firmly fixed.

### Third Embodiment

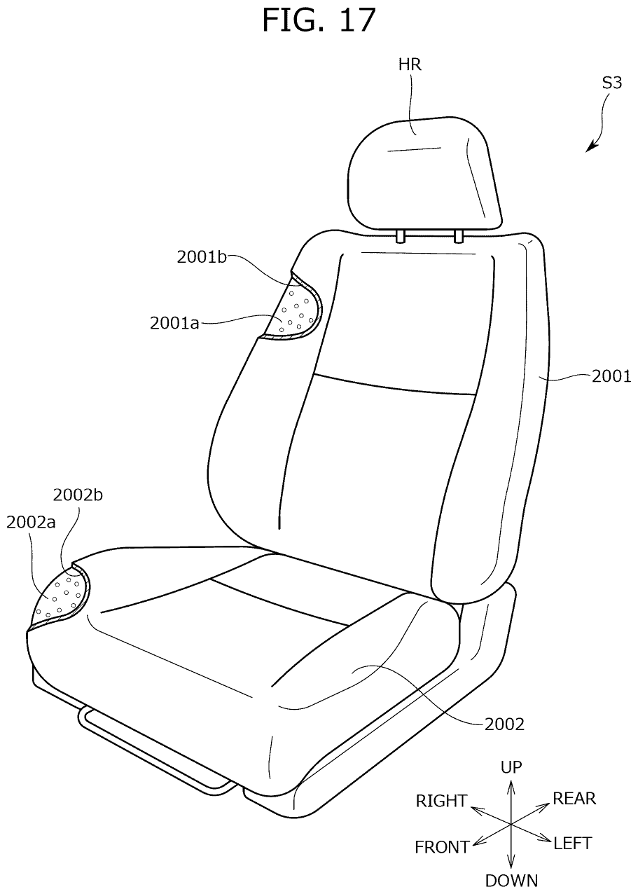

A conveyance seat S3 of a third embodiment will be described with reference to FIGS. 17 to 21.

Incidentally, the description of contents that overlap with those of the conveyance seats S1 and S2 described above will be omitted.

In the conveyance seat S3, the state of components disposed below a pressure receiving member made of a plate material can be checked.

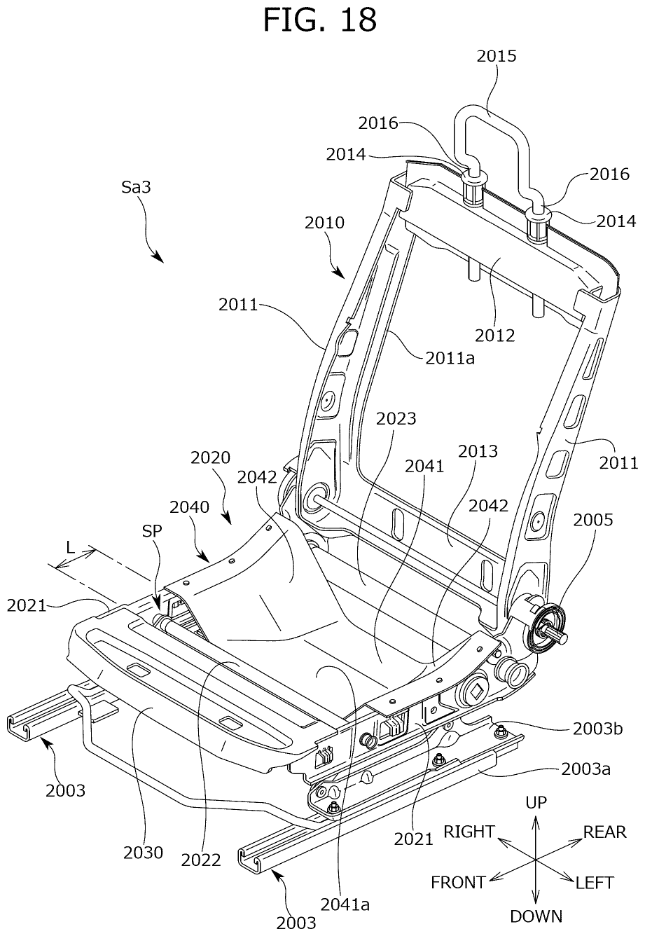

As shown in FIG. 17, the conveyance seat S3 includes, as main components, a seat back 2001 serving as a backrest portion that supports the back of a seated occupant; a seat cushion 2002 serving as a seating portion that supports the buttocks of the seated occupant; and a headrest HR disposed on an upper portion of the seat back 2001 and supporting the head of the seated occupant. The seat back 2001 and the seat cushion 2002 are connected to sandwich a reclining device 2005 (refer to FIG. 18) therebetween. The seat back 2001 is rotatable with respect to the seat cushion 2002 by the reclining device 2005, and the inclination angle of the seat back 2001 can be adjusted.

### <<Seat Frame>>

As shown in FIG. 18, a seat frame Sa3 serving as a skeleton of the conveyance seat S3 includes a back frame 2010 forming a skeleton of the seat back 2001, and a cushion frame 2020 forming a skeleton of the seat cushion 2002.

Hereinafter, first, configurations other than the cushion frame 2020, such as the back frame 2010, will be described, and details of the cushion frame 2020 including a pressure receiving member 2040 will be described thereafter.

### <<Back Frame>>

As shown in FIG. 18, the back frame 2010 is formed in a rectangular frame shape as a whole, and the back frame 2010 includes a pair of back side frames 2011 disposed on the right and left sides; an upper frame 2012; and a lower frame 2013. The upper frame 2012 is disposed between the pair of back side frames 2011, and connects upper ends of the pair of back side frames 2011. The lower frame 2013 is disposed between the pair of back side frames 2011, and connects lower ends of the pair of back side frames 2011.

The upper frame 2012 is provided with headrest guides 2014 into which headrest stays 2016 of the headrest HR are inserted. Incidentally, in order to maintain the holding strength of the headrest HR and suppress looseness of the headrest HR, the headrest guides 2014 are formed as high-strength metal members. Incidentally, the headrest guides 2014 are not limited to being made of metal, and may be made of resin.

The pair of back side frames 2011 are members disposed on the right and left sides of the back frame 2010 as described above and basically having a right-left symmetrical configuration. The pair of back side frames 2011 are provided to extend in a seat up to down direction. The width of each of the pair of back side frames 2011 in a seat front to rear direction is formed to increase as each of the pair of back side frames 2011 extends from a seat upper side toward a seat lower side. Each of the back side frames 2011 is formed in a curved shape such that a peripheral edge portion on a seat front side and a peripheral edge portion on a seat rear side protrude toward the seat front side. A rear wall portion 2011a extending inward in a seat width direction is formed at the peripheral edge portion on the seat rear side of each of the pair of back side frames 2011.

### <<Headrest and Headrest Frame>>

The headrest HR is attached to the upper portion of the seat back 2001 to support the head of the seated occupant. Inside the headrest HR, a headrest frame 2015 forming a skeleton of the headrest HR is provided, and two headrest stays 2016 (also referred to as headrest pillars) hanging down from a lower portion of the headrest HR are provided at both right and left ends of the headrest frame 2015. By inserting the headrest stays 2016 into the headrest guides 2014 attached to the upper frame 2012 of the back frame 2010, the headrest HR is attached to the back frame 2010.

### <<Pad Material and Skin Material>>

The seat back 2001, the seat cushion 2002, and the headrest HR are configured by providing pad materials 2001a and 2002a and skin materials 2001b and 2002b (cushion covers) on outer sides of the back frame 2010, the cushion frame 2020, and the headrest frame 2015. The pad materials 2001a and 2002a are, for example, urethane base materials molded by foam molding using a urethane foam material, and the skin materials 2001b and 2002b are made of, for example, cloth, synthetic leather, genuine leather, or the like.

### <<Rail Device>>

In addition, as shown in FIG. 18, a rail device 2003 is installed below the conveyance seat S3. The conveyance seat S3 is attached to a vehicle body floor in a state where the conveyance seat S3 is slidably movable in the front to rear direction by the rail device 2003.

The rail device 2003 is a device for slidably moving the conveyance seat S3 along the front to rear direction, and has a known structure (structure of a general rail device mechanism). The rail device 2003 includes lower rails 2003a fixed onto the vehicle body floor, and upper rails 2003b that are slidably movable with respect to the lower rails 2003a. The upper rails 2003b are slidable with respect to the lower rails 2003a fixed to a vehicle body.

### <<Reclining Device>>

The reclining device 2005 is provided between a lower end portion of the seat back 2001 and a rear end portion of the seat cushion 2002. In more detail, the reclining device 2005 connects the back frame 2010 of the seat back 2001 and the cushion frame 2020 of the seat cushion 2002. The reclining device 2005 can adjust the angle of the seat back 2001 (back frame 2010) with respect to the seat cushion 2002 (cushion frame 2020). A state where the seat back 2001 is inclined and locked at a predetermined angle can be maintained by the reclining device 2005. In addition, the seat back 2001 can be reclined forward or rearward by releasing the lock.

Hereinafter, the cushion frame 2020 included in the conveyance seat S3 of the present embodiment will be described with reference to FIGS. 18 to 21.

### <<Cushion Frame>>

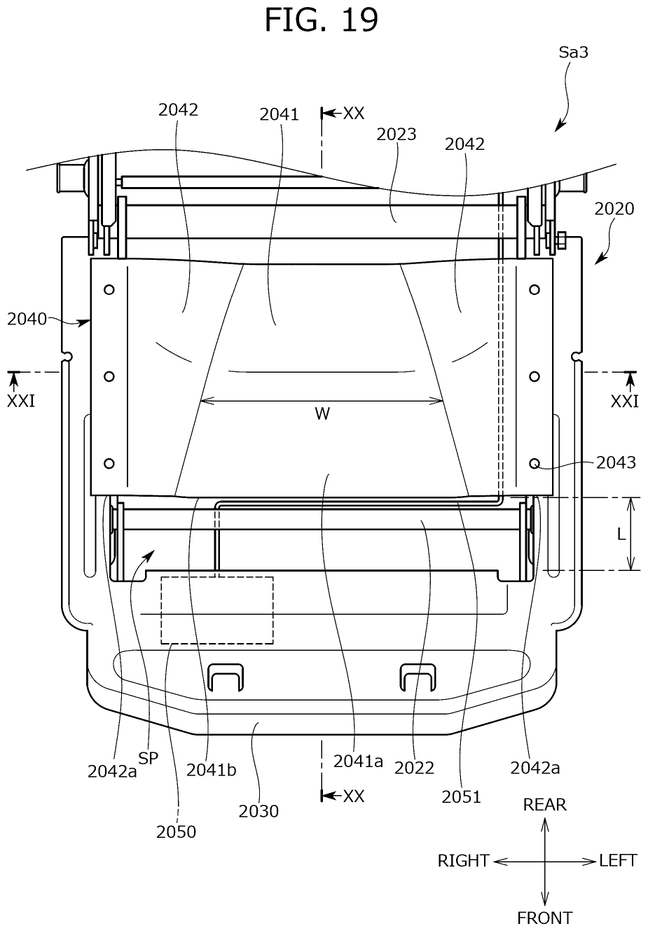

As shown in FIG. 19, the cushion frame 2020 is formed in a rectangular frame shape in top view, and a pair of side frames 2021 are provided on the right and left sides. The pair of side frames 2021 are members basically having a right-left symmetrical configuration, and are provided to extend in the seat front to rear direction.

In addition, the cushion frame 2020 includes a front connecting frame 2022 (front connection member) connecting the pair of side frames 2021 on the front side, and a rear connecting frame 2023 (rear connection member) connecting the pair of side frames 2021 on the rear side. The front connecting frame 2022 and the rear connecting frame 2023 are made of round pipes. In addition, a pan frame 2030 (pan frame) is provided further in front of the front connecting frame 2022. Incidentally, as will be described later, the front connecting frame 2022 is disposed below a gap SP formed between the pan frame 2030 and the pressure receiving member 2040.

### <<Pressure Receiving Member>>

One configuration example of the pressure receiving member 2040 constituting a main part of the present embodiment will be described in detail. As shown in FIGS. 18 and 19, the cushion frame 2020 is provided with the pressure receiving member 2040 that is disposed to bridge between the pair of side frames 2021.

The pressure receiving member 2040 is, for example, a member formed by press-forming a plate-shaped member made of metal such as iron or aluminum. As shown in FIG. 18, the pressure receiving member 2040 has a shape that is recessed downward, and the pressure receiving member 2040 is configured to support the buttocks of the occupant seated in the conveyance seat S3 in its entirety. Incidentally, the pressure receiving member 2040 is not limited to a plate-shaped member made of metal such as iron or aluminum, and may be formed from a member made of resin such as fiber-reinforced plastic (FRP).

In more detail, the pressure receiving member 2040 includes a bottom portion 2041 at a central portion of the pressure receiving member 2040 in the seat width direction, the bottom portion 2041 being provided at a position lower in height than the pair of side frames 2021. In addition, the pressure receiving member 2040 includes side inclined portions 2042 that are inclined upward from both side portions of the bottom portion 2041 toward the pair of side frames 2021. In other words, the side inclined portions 2042 have a shape which is inclined such that the distance therebetween in the seat width direction increases as the side inclined portions 2042 extend from both the side portions of the bottom portion 2041 toward the upper side.

Further, as shown in FIG. 19, a front end 2041b of the bottom portion 2041 and front ends 2042a of the side inclined portions 2042 are disposed on the same straight line, and constitute a front end of the pressure receiving member 2040.

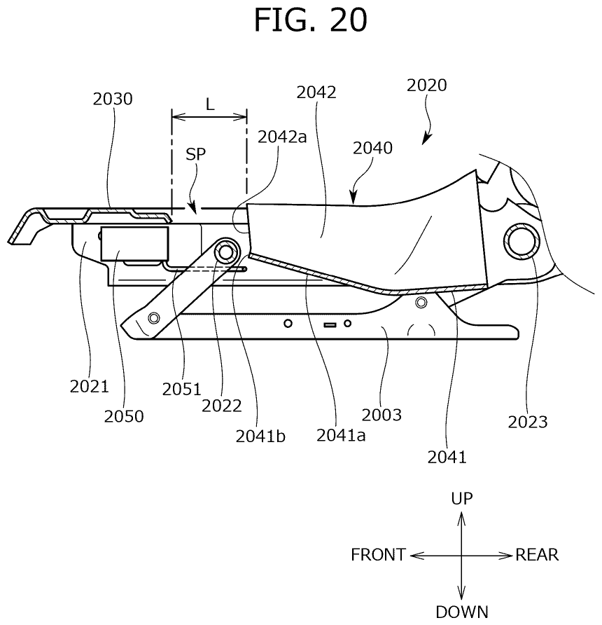

In addition, as shown in FIG. 20, the bottom portion 2041 includes a front inclined portion 2041a that is inclined upward toward the front connecting frame 2022 disposed in front of the pressure receiving member 2040. In addition, as shown in FIG. 19, the front inclined portion 2041a is formed such that the width of the front inclined portion 2041a, namely, a length W in the seat width direction increases as the front inclined portion 2041a extends toward the front connecting frame 2022.

The pressure receiving member 2040 includes the bottom portion 2041 and the side inclined portions 2042 formed as described above, so that the pressure receiving member 2040 conforms to the body shape of the seated occupant when seated. Therefore, the pressure receiving member 2040 can support the seated occupant over a wider area via the pad material 2002a compared to when the pressure receiving member 2040 is formed in a flat plate shape, so that seating comfort when seated is improved.

In addition, the pressure receiving member 2040 is fixed to the side frames 2021 at both side portions thereof by a mechanical method using fastening members such as bolts 2043 or rivets. The fixing method is not limited to using bolts or the like, and the pressure receiving member 2040 and the side frames 2021 may be fixed using welding, adhesive agent, or the like.

As shown in FIGS. 18 to 20, the pressure receiving member 2040 is disposed with the gap SP of a predetermined distance L provided between the pressure receiving member 2040 and the pan frame 2030. The gap SP is located above the front connecting frame 2022 connecting the pair of side frames 2021. Namely, the front connecting frame 2022 is provided to be located below the gap SP.

For that reason, when assembling the conveyance seat S3, a worker can check the state of the front connecting frame 2022 by looking at the cushion frame 2020 from above.

In addition, as shown in FIGS. 19 and 20, the front end of the pressure receiving member 2040 may be located behind a rear end of the front connecting frame 2022. Compared to when the front end of the pressure receiving member 2040 overlaps the front connecting frame 2022, it becomes easy to check the state of the front connecting frame 2022.

In addition, since the bottom portion 2041 of the pressure receiving member 2040 includes the front inclined portion 2041a that is inclined upward toward the front connecting frame 2022, it becomes easy to check the state of the front connecting frame 2022.

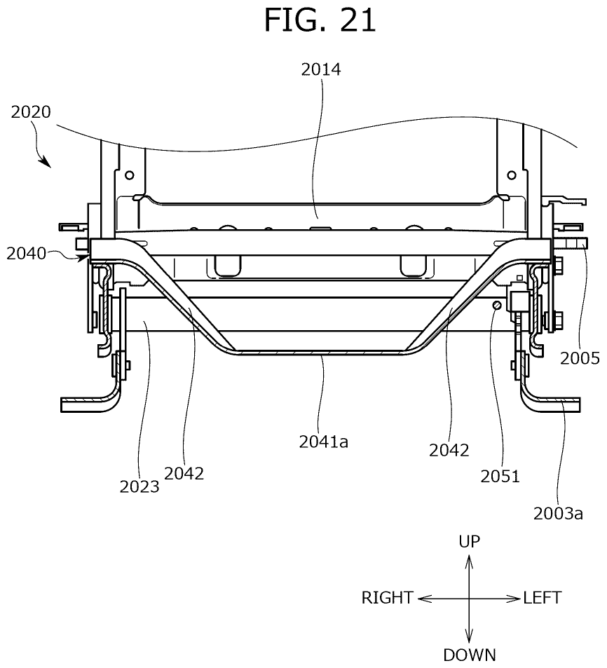

In addition, the pressure receiving member 2040 is disposed to be located in front of the rear connecting frame 2023 connecting the pair of side frames 2021 on the rear side. Further, as shown in FIGS. 20 and 21, the pressure receiving member 2040 is formed such that a rear end of the bottom portion 2041 of the pressure receiving member 2040 is located below the rear connecting frame 2023.

Since the seat back 2001 is disposed above the rear connecting frame 2023, it is difficult to check the rear connecting frame 2023 on the rear side from above. For that reason, the state of the rear connecting frame 2023 is checked from the front of the seat. By locating the rear end of the bottom portion 2041 below the rear connecting frame 2023, when the rear connecting frame 2023 is viewed from the front of the seat, the state of the rear connecting frame 2023 can be checked without being obstructed by the bottom portion 2041 of the pressure receiving member 2040.

In addition, as shown in FIGS. 20 and 21, an upper end of the pressure receiving member 2040, namely, the side portions of the pressure receiving member 2040 connected to the side frames 2021 are disposed to be located above the rear connecting frame 2023. On the other hand, as described above, the rear end of the bottom portion 2041 of the pressure receiving member 2040 is located below the rear connecting frame 2023. By forming the pressure receiving member 2040 in such a manner, the seated occupant can be supported over a wider area, so that seating comfort is improved.

In addition, the pressure receiving member 2040 and the rear connecting frame 2023 are disposed at a distance from each other in the front to rear direction, and the pressure receiving member 2040 is disposed not to come into contact with the rear connecting frame 2023. By disposing the pressure receiving member 2040 and the rear connecting frame 2023 so as not to come into contact with each other, rubbing noise caused by the pressure receiving member 2040 and the rear connecting frame 2023 can be suppressed.

An electronic control unit (ECU) 2050 is disposed in the seat cushion 2002 of the present embodiment. The ECU 2050 is an electronic control unit that controls electrical components or drive devices provided in the conveyance seat S3, for example, a lock device or a reclining device. As shown in FIG. 21, the ECU 2050 is provided below the pan frame 2030. A harness member 2051 for connecting to electrical components and the like extends from the ECU 2050, and as shown in FIGS. 20 and 21, the harness member 2051 is disposed along the front connecting frame 2022 between the pressure receiving member 2040 and the front connecting frame 2022. After the harness member 2051 has reached the left side frame 2021, the harness member 2051 is disposed up to the rear of the conveyance seat S3 through a space formed below the side inclined portion 2042. Since the harness member 2051 is disposed between the pressure receiving member 2040 and the front connecting frame 2022, the state of the harness member 2051 can be easily checked from above through the gap SP.

### <<Additional Notes>>

A conveyance seat S4 may include a seat frame. The seat frame may include a pair of side frames disposed on right and left sides of the seat frame, a pan frame disposed to bridge below the pair of side frames on a front side of the seat frame, a pressure receiving member formed from a plate-shaped member, disposed behind the pan frame, disposed to bridge between the pair of side frames, and disposed with a gap of a predetermined distance provided between the pressure receiving member and the pan frame, and a front connection member provided below the gap and connecting the pair of side frames.

By providing the gap of the predetermined distance between the pressure receiving member formed from a plate-shaped member and the pan frame, the state of the front connection member provided below the gap can be checked from above. Since it becomes easy to perform checking, work efficiency when the vehicle seat is assembled is improved.

According to the conveyance seat, a front end of the pressure receiving member may be located behind a rear end of the front connection member.

By locating the front end of the pressure receiving member behind the rear end of the connection member, it is made easier to check the state of the connection member.

According to the conveyance seat, the pressure receiving member may include a bottom portion at a central portion of the pressure receiving member in a seat width direction, the bottom portion being provided at a position lower in height than the pair of side frames, and side inclined portions that are inclined upward from both side portions of the bottom portion toward the pair of side frames. A front end of the bottom portion and front ends of the side inclined portions may be disposed on the same straight line.

With the above-described configuration, the pressure receiving member conforms to the body shape of a seated occupant when seated, so that the seated occupant can be supported over a wider area. Therefore, seating comfort when seated is improved.

In addition, by disposing the front end of the bottom portion and the front end of the side inclined portions on the same straight line, it is made easier to check the state of the connection member located below.

According to the conveyance seat, the bottom portion may include a front inclined portion that is inclined upward toward the front connection member.

With the above-described configuration, the pressure receiving member conforms to the body shape of the seated occupant when seated, so that the seated occupant can be supported over a wider area. Therefore, seating comfort when seated is improved.

According to the conveyance seat, the bottom portion may include a portion that is increased in width as the portion extends toward the front connection member.

With the above-described configuration, the pressure receiving member conforms to the body shape of the seated occupant when seated, so that the seated occupant can be supported over a wider area. Therefore, seating comfort when seated can be improved.

According to the conveyance seat, the seat frame may include a rear connection member connecting the pair of side frames behind the pressure receiving member. A rear end of the bottom portion of the pressure receiving member may be located below the rear connection member.

By locating the rear end of the bottom portion of the pressure receiving member below the rear connection member, it is made easier to check the state of the rear connection member.

According to the conveyance seat, an upper end of the pressure receiving member may be located above the rear connection member.

By locating the upper end of the pressure receiving member above the rear connection member, a pad material disposed on the pressure receiving member can be supported over a wider area, so that seating comfort when seated can be improved.

In addition, according to the conveyance seat, the pressure receiving member may not be in contact with the rear connection member.

By disposing the pressure receiving member and the rear connection member so as not to come into contact with each other, rubbing noise occurring when the pressure receiving member and the rear connection member rub against each other can be suppressed.

In addition, according to the conveyance seat, a harness member may be disposed between the pressure receiving member and the front connection member.

By disposing the harness member between the pressure receiving member and the front connection member, it is made easy to check the state of the harness member through the gap.

In addition, according to the conveyance seat, a pad material disposed on the seat frame and a skin material covering the pad material may be provided.

Since the seat frame is provided with the pad member and the skin material covering the pad material, a good seating feeling can be provided to the seated occupant.

### Fourth Embodiment

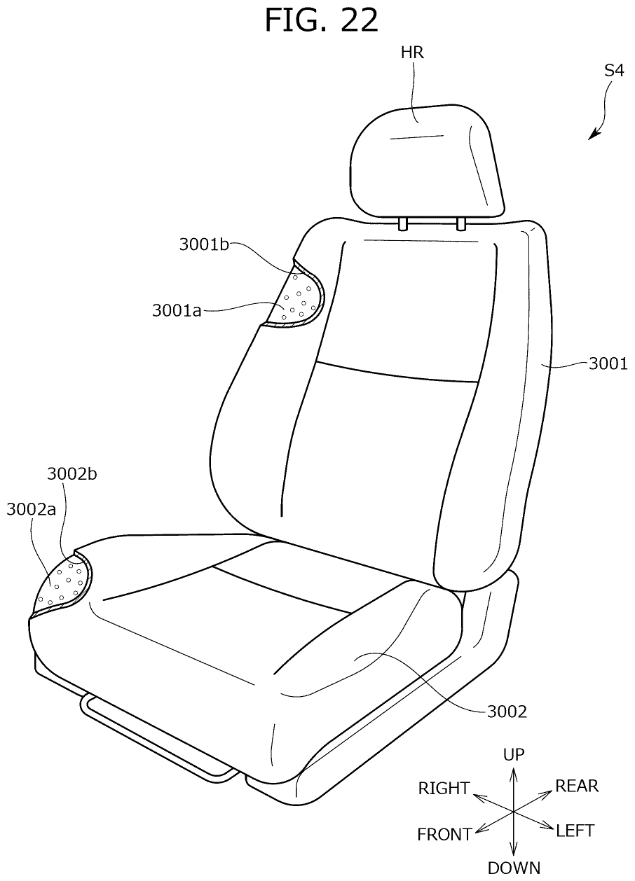

A conveyance seat S4 of a fourth embodiment will be described with reference to FIGS. 22 to 26D.

Incidentally, the description of contents that overlap with those of the conveyance seats S1 to S3 described above will be omitted.

The conveyance seat S4 realizes a seat including a pressure receiving member having a plate shape and attached to side frames with good spring performance.

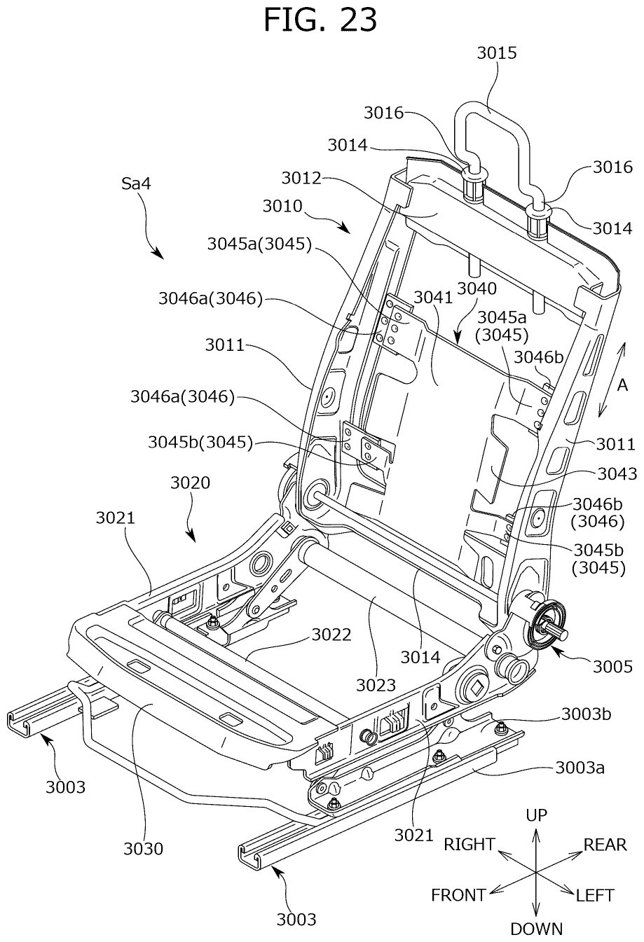

As shown in FIG. 22, the conveyance seat S4 includes, as main components, a seat back 3001 serving as a backrest portion that supports the back of a seated occupant; a seat cushion 3002 serving as a seating portion that supports the buttocks of the seated occupant; and a headrest HR disposed on an upper portion of the seat back 3001 and supporting the head of the seated occupant. The seat back 3001 and the seat cushion 3002 are connected to sandwich a reclining device 3005 (refer to FIG. 23) therebetween. The seat back 3001 is rotatable with respect to the seat cushion 3002 by the reclining device 3005, and the inclination angle of the seat back 3001 can be adjusted.

### <<Seat Frame>>

As shown in FIG. 23, a seat frame Sa4 serving as a skeleton of the conveyance seat S4 includes a back frame 3010 forming a skeleton of the seat back 3001, and a cushion frame 3020 forming a skeleton of the seat cushion 3002.

Hereinafter, first, configurations other than the back frame 3010, such as the cushion frame 3020, will be described, and details of the back frame 3010 will be described thereafter.

### <<Cushion Frame>>

The cushion frame 3020 is formed in a rectangular frame shape, and a pair of side frames 3021 are provided at right and left side portions of the cushion frame 3020. In addition, the cushion frame 3020 includes a front connecting frame 3022 connecting the pair of side frames 3021 and 3021 on the front side, and a rear connecting frame 3023 connecting the side frames 3021 and 3021 on the rear side. The front connecting frame 3022 and the rear connecting frame 3023 located in the front and rear of the conveyance seat S4 are made of round pipes. In addition, a pan frame 3030 is provided further in front of the rear connecting frame 3023.

### <<Headrest and Headrest Frame>>

The headrest HR is attached to the upper portion of the seat back 3001 to support the head of the seated occupant. Inside the headrest HR, a headrest frame 3015 forming a skeleton of the headrest HR is provided, and two headrest stays 3016 (also referred to as headrest pillars) hanging down from a lower portion of the headrest HR are provided at both right and left ends of the headrest frame 3015. By inserting the headrest stays 3016 into headrest guides 3014 attached to an upper frame 3012 of the back frame 3010, the headrest HR is attached to the back frame 3010.

### <<Pad Material and Skin Material>>

The seat back 3001, the seat cushion 3002, and the headrest HR are configured by providing pad materials 3001a and 3002a and skin materials 3001b and 3002b (cushion covers) on outer sides of the back frame 3010, the cushion frame 3020, and the headrest frame 3015. The pad materials 3001a and 3002a are, for example, urethane base materials molded by foam molding using a urethane foam material, and the skin materials 3001b and 3002b are made of, for example, cloth, synthetic leather, genuine leather, or the like.

### <<Rail Device>>

In addition, as shown in FIG. 23, a rail device 3003 is installed below the conveyance seat S4. The conveyance seat S4 is attached to a vehicle body floor in a state where the conveyance seat S4 is slidably movable in a front to rear direction by the rail device 3003.

The rail device 3003 is a device for slidably moving the conveyance seat S4 along the front to rear direction, and has a known structure (structure of a general rail device mechanism). The rail device 3003 includes lower rails 3003a fixed onto the vehicle body floor, and upper rails 3003b that are slidably movable with respect to the lower rails 3003a. The upper rails 3003b are slidable with respect to the lower rails 3003a fixed to a vehicle body.

### <<Reclining Device>>

The reclining device 3005 is provided between a lower end portion of the seat back 3001 and a rear end portion of the seat cushion 3002. In more detail, the reclining device 3005 connects the back frame 3010 of the seat back 3001 and the cushion frame 3020 of the seat cushion 3002. The reclining device 3005 can adjust the angle of the seat back 3001 (back frame 3010) with respect to the seat cushion 3002 (cushion frame 3020).

A state where the seat back 3001 is inclined and locked at a predetermined angle can be maintained by the reclining device 3005. In addition, the seat back 3001 can be reclined forward or rearward by releasing the lock.

### <<Back Frame>>

As shown in FIG. 23, the back frame 3010 is formed in a rectangular frame shape as a whole, and the back frame 3010 includes a pair of back side frames 3011 disposed on the right and left sides; the upper frame 3012; and a lower frame 3013. The upper frame 3012 is a connection member disposed between the pair of back side frames 3011 and connecting upper ends of the pair of back side frames 3011. The lower frame 3013 is a connection member disposed between the pair of back side frames 3011 and connecting lower ends of the pair of back side frames 3011.

The upper frame 3012 is provided with the headrest guides 3014 into which headrest stays 3016 of the headrest HR are inserted. In order to maintain the holding strength of the headrest HR and suppress looseness of the headrest HR, the headrest guides 3014 are formed as high-strength metal members. Incidentally, the headrest guides 3014 are not limited to being made of metal, and may be made of resin.

### <<Back Side Frame>>

The pair of back side frames 3011 are members disposed on the right and left sides of the back frame 3010 as described above and basically having a right-left symmetrical configuration. The pair of back side frames 3011 are provided to extend in a seat up to down direction (predetermined extending direction, in more detail, the direction of arrow A in FIG. 23). The width of each of the pair of back side frames 3011 in the seat front to rear direction is formed to increase as each of the pair of back side frames 3011 extends from a seat upper side toward a seat lower side. Each of the back side frames 3011 is formed in a curved shape such that a peripheral edge portion on a seat front side and a peripheral edge portion on a seat rear side protrude toward the seat front side. Rear wall portions 3011a extending inward in a seat width direction are formed at the peripheral edge portion on the seat rear side of each of the pair of back side frames 3011, and a pressure receiving member 3040 to be described later is attached to the rear wall portions 3011a.

### <<Pressure Receiving Member>>

One configuration example of the pressure receiving member 3040 constituting a main part of the present embodiment will be described in detail. As shown in FIGS. 23 to 25, the back frame 3010 is provided with the pressure receiving member 3040 that bridges between the pair of back side frames 3011. The pressure receiving member 3040 is a plate-shaped member made of metal, and includes a body portion 3041 formed in a rectangular shape; extending portions 3045 extending from side portions 3042 on both sides of the body portion 3041 in the seat width direction; and a pair of protruding portions 3043 protruding from the side portions 3042 in the seat width direction. In addition, a pair of protruding portions 3044 protruding in the seat width direction are also provided at lower end portions of the side portions 3042.

The pressure receiving member 3040 is fixed to the pair of back side frames 3011 via elastic members 3046. In more detail, the pressure receiving member 3040 is fixed from both sides by first elastic members 3046a attached to one (right side) of the pair of back side frames 3011 and second elastic members 3046b attached to the other (left side).

The first elastic members 3046a are connected to one (right side) back side frame 3011, and are not connected to the other (left side) back side frame 3011.

The second elastic members 3046b are connected to the other (left side) back side frame 3011, and are not connected to the one (right side) back side frame 3011.

Since the pressure receiving member 3040 and the elastic members 3046 are separate bodies, the pressure receiving member 3040 and the elastic members 3046 can be manufactured at a lower cost compared to when the pressure receiving member 3040 and the elastic members 3046 are integrated. In addition, since the pressure receiving member 3040 is fixed to the back side frames 3011 from both sides by the elastic members 3046 that are separate bodies, the pressure receiving member 3040 has good spring performance.

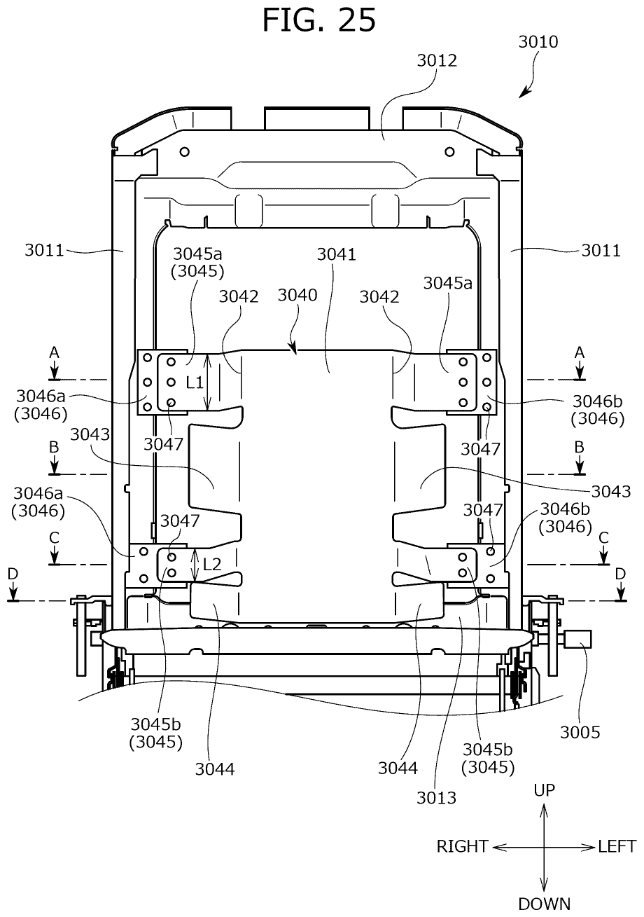

In addition, as shown in FIGS. 23 to 25, the elastic members 3046 are leaf spring members made of metal and formed in a plate shape, and are attached to the rear wall portions 3011a of the back side frames 3011 so as to flex in the seat front to rear direction. The first elastic members 3046a are composed of two leaf spring members disposed at a distance from each other in the up to down direction, and are independently attached to the pressure receiving member 3040. As shown in FIG. 25, a length of the back side frames 3011, which are leaf spring members, in the up to down direction is set according to lengths (L1 and L2) of the extending portions 3045 of the pressure receiving member 3040 to which the back side frames 3011 are connected.

In addition, the second elastic members 3046b are also composed of two leaf spring members disposed at a distance from each other in the up to down direction, and are independently attached to the pressure receiving member 3040. A length of the two leaf spring members, which constitute the second elastic members 3046b, in the up to down direction is also set according to the lengths (L1 and L2) of the extending portions 3045 connected thereto.

A mechanical fixing method using rivets 3047, bolts, or the like is used for connection between the pressure receiving member 3040 and the elastic members 3046 and connection between the back side frames 3011 and the elastic members 3046. These members may be attached and connected using an adhesive agent.

Connection between the pressure receiving member 3040 and the elastic members 3046 and connection between the back side frames 3011 and the elastic members 3046 can also be fixed by welding; however, it is desirable that these members are mechanically fixed using the rivets 3047 or the like in consideration of spring performance, strength, or the like.

Incidentally, the elastic member 3046 is not limited to a leaf spring, and may be a wire-shaped spring member formed from a wire or the like.

A shape of the pressure receiving member 3040 will be described in more detail. The pressure receiving member 3040 includes the extending portions 3045 extending from the side portions of the body portion 3041 as described above, and the elastic members 3046 are connected to the extending portions 3045. The extending portion 3045 includes a first extending portion 3045a located on the upper side (one end side) in the up to down direction (extending direction A), and a second extending portion 3045b located on the lower side (the other end side).

In addition, in the present embodiment, by setting the length L1 of the first extending portion 3045a in the up to down direction to be longer than the length L2 of the second extending portion 3045b in the up to down direction, the spring performance that supports the pressure receiving member 3040 is adjusted (refer to FIG. 25). By dividing the extending portion 3045 in the up to down direction and by changing the length L1 of the first extending portion 3045a in the up to down direction and the length L2 of the second extending portion 3045b, the spring performance of the elastic member 3046 connected to the extending portion 3045, for example, the amount of flexure can be adjusted. For that reason, the spring performance of the pressure receiving member 3040 can be improved, and the feeling when seated can be improved.

In addition, as described above, the pair of protruding portions 3043 protruding from the side portions 3042 in the width direction (right to left direction) are provided between the first extending portions 3045a and the second extending portions 3045b. The pair of protruding portions 3043 are portions that support the back of the seated occupant when a load is applied to the pressure receiving member 3040 from the back of the seated occupant.

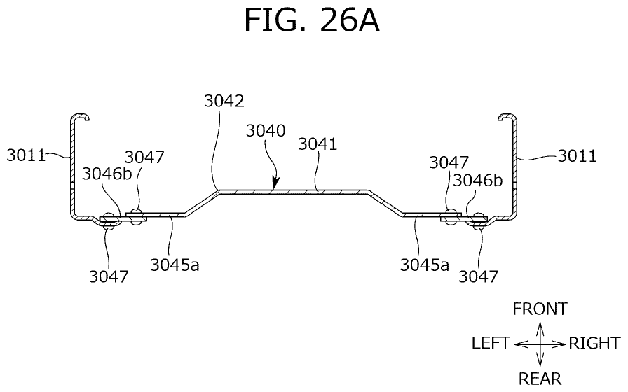

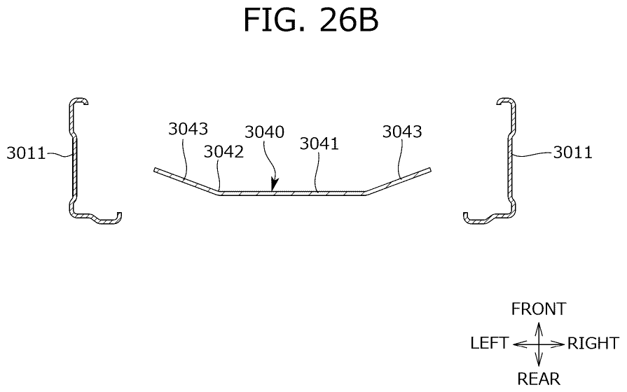

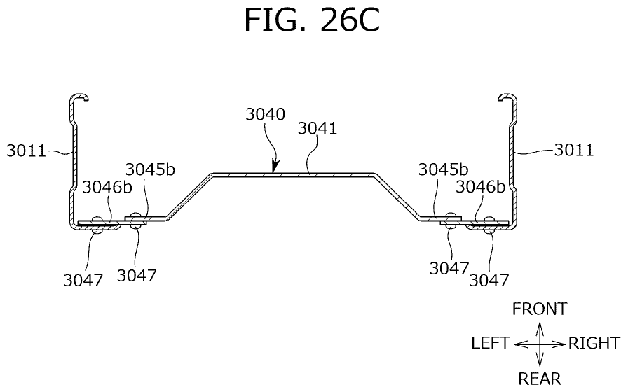

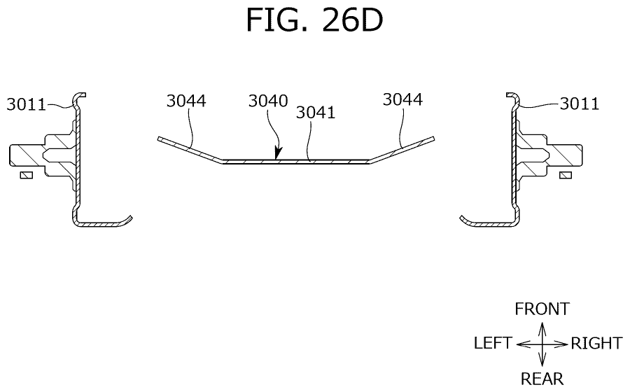

As shown in FIG. 26B, in order to conform to the back of the seated occupant, the pair of protruding portions 3043 are inclined such that tip portions approach the seated occupant from the side portions 3042 of the body portion 3041, namely, approach a backrest surface on which the seated occupant leans. In other words, the pair of protruding portions 3043 are inclined such that the distance from one protruding portion 3043 to the other protruding portion 3043 increases as the pair of protruding portions 3043 extend toward the front.

In addition, the pair of protruding portions 3044 protruding from the side portions 3042 in the width direction are provided below the second extending portions 3045b. Similarly to the pair of protruding portions 3043, the pair of protruding portions 3044 are also inclined such that tip portions approach a seated occupant side.

The protruding portions 3043 and 3044 protruding from the body portion 3041 are inclined in such a manner, so that the range in which a load from the seated occupant is accepted is expanded. Therefore, the feeling when seated is improved.

In addition, as shown in FIGS. 26A and 26C, the body portion 3041 of the pressure receiving member 3040 is disposed closer to the seat front side, namely, the backrest surface than the extending portions 3045a and 3045b. The position of the pressure receiving member 3040 is adjusted by providing inclined portions between end portions of the extending portions and side portions of the pressure receiving member 3040, and is such that the body portion 3041 can receive a load. By disposing the pressure receiving member 3040 so as to be closer to the backrest surface through adjusting the position of the pressure receiving member 3040 using the extending portions 3045, the feeling when seated is improved.

In the present embodiment, a lower end portion (one example of one end in the extending direction) of the pressure receiving member 3040 is disposed to overlap the lower frame 3013 (connection member) when viewed from the front of the seat. By disposing the lower end portion of the pressure receiving member 3040 so as to overlap the lower frame 3013, for example, when the seat receives a strong load in the event of collision, the pressure receiving member 3040 can be supported by the lower frame 3013.

With such disposition, the supportiveness of the pressure receiving member 3040 is improved by cooperation between the elastic members 3046 and the lower frame 3013. Incidentally, in the present embodiment, the lower end portion of the pressure receiving member 3040 is disposed to overlap the lower frame 3013 when viewed from the front; however, such disposition is one example, an upper end portion of the pressure receiving member 3040 may be disposed to overlap the upper frame 3012 when viewed from the front of the seat. In addition, the upper end portion of the pressure receiving member 3040 may overlap the upper frame 3012, and the lower end portion may overlap the lower frame 3013.

As one embodiment of the present invention, the pressure receiving member 3040 provided to bridge between the pair of back side frames 3011 of the back frame 3010 has been described. This embodiment is one example, and a pressure receiving member may be provided to bridge between the pair of side frames 3021 constituting the cushion frame 3020.

When the cushion frame 3020 is provided with the pressure receiving member, the pressure receiving member receives a load from the buttocks of the seated occupant, and is fixed by first elastic members and second elastic members attached to the pair of side frames 3021 disposed on the right and left sides.

In addition, when the pressure receiving member is attached to the pair of side frames 3021, the predetermined extending direction becomes the front to rear direction, and the pressure receiving member includes first extending portions located on the front side in the front to rear direction, and second extending portions located on the rear side.

In addition, the pressure receiving member is disposed such that a front end of the pressure receiving member overlaps the front connecting frame 3022 connecting the pair of side frames 3021 in top view. A rear end of the pressure receiving member may be disposed to overlap the rear connecting frame 3023 in top view.

### <<Additional Notes>>

A conveyance seat S4 may include a seat frame. The seat frame may include a pair of side frames disposed on right and left sides of the seat frame and extending in a predetermined extending direction, and a pressure receiving member having a plate shape and disposed to bridge between the pair of side frames. The pressure receiving member may be fixed to the pair of side frames by an elastic member. The elastic member may include a first elastic member attached to one of the pair of side frames, and a second elastic member attached to the other of the pair of side frames.

The pressure receiving member having a plate shape is attached to the pair of side frames by the separate elastic member. For that reason, the conveyance seat including the pressure receiving member having a plate shape and attached with good spring performance at low cost.

In addition, since the elastic member includes the first elastic member attached to the one of the pair of side frames, and the second elastic member attached to the other, the elastic member can support the pressure receiving member in a well-balanced manner.

According to the conveyance seat, the elastic member may be a plate-shaped spring member.

The spring performance is improved by using a plate-shaped spring member as the elastic member.

According to the conveyance seat, the pressure receiving member may include a body portion and an extending portion extending from a side portion of the body portion. The elastic member may be connected to the extending portion.

Since the elastic member is connected to the extending portion of the pressure receiving member, the spring performance is further improved.

According to the conveyance seat, the extending portion may include a first extending portion located on one end side of the side portion of the pressure receiving member in the extending direction, and a second extending portion located on the other end side of the pressure receiving member.

Since the extending member includes the first extending member located on the one end side of the side portion of the pressure receiving member in the extending direction, and the second extending portion located on the other end side, the spring performance is improved.

According to the conveyance seat, a length of the first extending portion in the extending direction may be formed to be longer than a length of the second extending portion in the extending direction.

The spring performance can be appropriately adjusted by forming the length of the first extending portion in the extending direction so as to be longer than the length of the second extending portion in the extending direction.

According to the conveyance seat, the pressure receiving member may be provided with a protruding portion protruding from the side portion of the pressure receiving member in a seat width direction between the first extending portion and the second extending portion.

By providing the protruding portion protruding from the side portion of the pressure receiving member in the seat width direction, the area in which the pressure receiving member supports an occupant is expanded, and the feeling when seated is improved.

According to the conveyance seat, the protruding portion may be formed to be inclined toward a seating surface side of the conveyance seat.

By forming the protruding portion so as to be inclined toward the seating surface side, the seated occupant can be held such that movement in the width direction is suppressed, and the feeling when seated is further improved.

According to the conveyance seat, the body portion of the pressure receiving member may be disposed closer to a seating surface side of the conveyance seat than the extending portion.

By disposing the body portion of the pressure receiving member so as to be closer to the seating surface side than the extending portion, the supporting force for the occupant is improved by the pressure receiving member, and the feeling when seated is improved.

According to the conveyance seat, a connection member connecting the pair of side frames may be provided between the pair of side frames. One end of the pressure receiving member in the extending direction may be disposed to overlap the connection member.

By disposing the one end of the pressure receiving member so as to overlap the connection member connecting the side frames, the one end of the pressure receiving member is supported by the connection member, and the supportiveness of the pressure receiving member which supports the occupant is improved.

In addition, according to the conveyance seat, a pad material disposed on the seat frame and a skin material covering the pad material may be provided.

Since the seat frame is provided with the pad material and the skin material, a good seating feeling can be provided to the seated occupant.

### Fifth Embodiment

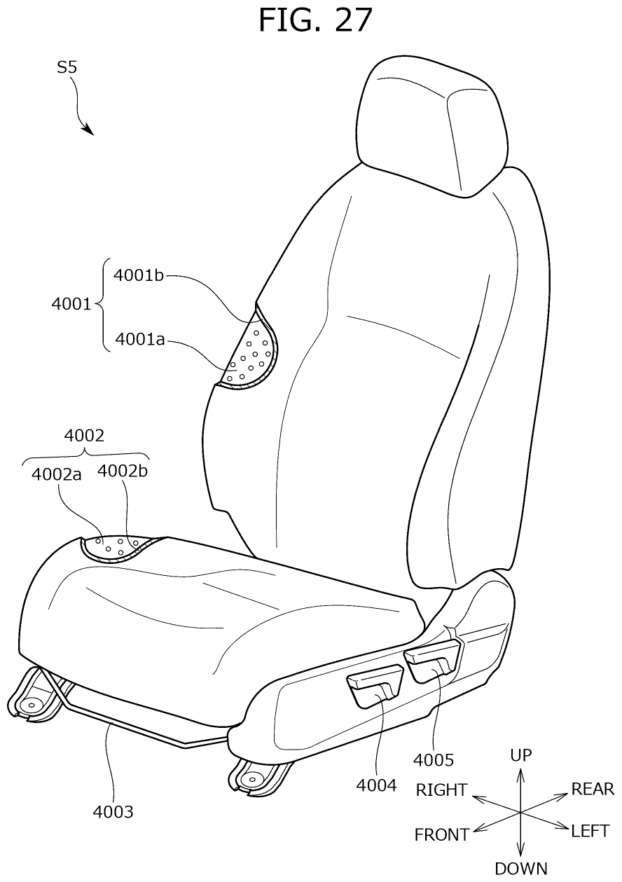

A conveyance seat S5 of a fifth embodiment will be described with reference to FIGS. 27 to 32.

Incidentally, the description of contents that overlap with those of the conveyance seats S1 to S4 described above will be omitted.

In the conveyance seat S5, a plurality of link members can be fixed with a simple configuration.

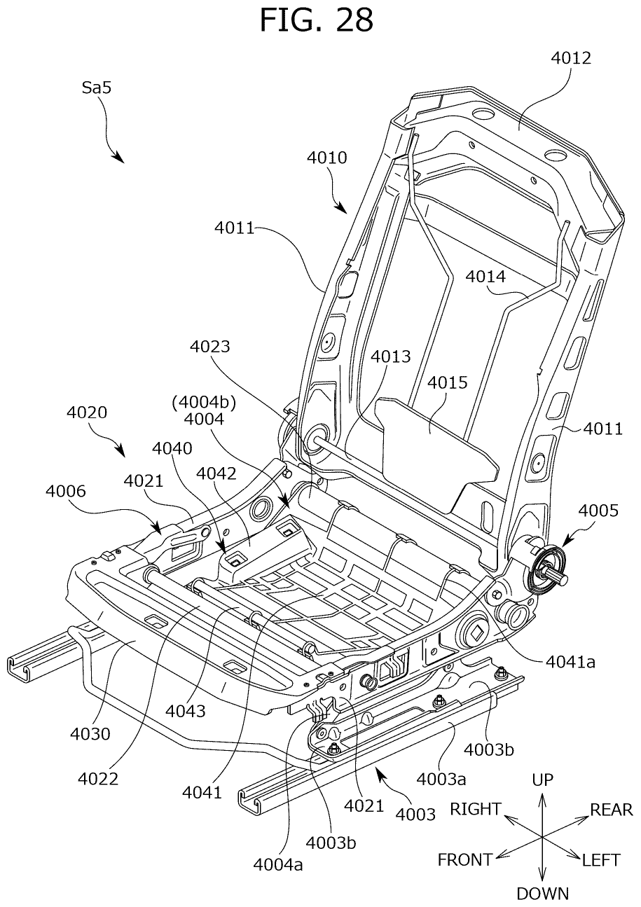

The conveyance seat S5 is a vehicle seat as shown in FIG. 27, and mainly includes a seat body including a seat back 4001 and a seat cushion 4002, and as shown in FIG. 28, a rail device 4003 that supports the seat body so as to be movable forward and rearward with respect to a vehicle body floor, a height link device 4004 that raisably and lowerably connects the seat body to the vehicle body floor, a reclining device 4005 that rotatably connects the seat back 4001 to the seat cushion 4002, and a tilt link device 4006 that tiltably connects a part of the seat body to the vehicle body floor.

As shown in FIG. 27, the seat back 4001 is a backrest portion that supports a seated occupant from the rear, and is configured by placing a pad material 4001a on a back frame 4010 serving as a skeleton shown in FIG. 28 and by covering the pad material 4001a with a skin material 4001b.

The seat cushion 4002 is a seating portion that supports the seated occupant from below, and is configured by placing a pad material 4002a on a cushion frame 4020 serving as a skeleton shown in FIG. 28 and by covering the pad material 4002a with a skin material 4002b.

As shown in FIG. 28, the rail device 4003 is disposed between the seat body and the vehicle body floor in an up to down direction, and mainly includes right and left lower rails 4003a fixed to the vehicle body floor and extending in a seat front to rear direction; right and left upper rails 4003b supported to be slidable along the lower rails 4003a; a lock member (not shown) that non-slidably locks the upper rails 4003b to the lower rails 4003a; and a rail operating lever (not shown) for releasing a locked state of the lock member.

The cushion frame 4020 is installed on upper surfaces of the right and left upper rails 4003b via the height link device 4004 in a bridging manner.

As shown in FIG. 28, the height link device 4004 is attached between the rail device 4003 and the cushion frame 4020, and mainly includes right and left first height links 4004a disposed on a seat front side; right and left second height links 4004b disposed on a seat rear side; a lock member (not shown) that non-raisably and non-lowerably locks the seat body; and a height operating lever (not shown) for releasing a locked state of the lock member. Further, the height link device 4004 is a device capable of adjusting the height of the seat body by using the second height links 4004b as drive links.

In addition, connection holes 4004c into which a front connecting frame 4022 is inserted are formed in the right and left first height links 4004a. The front connecting frame 4022 is rotatably held by the first height links 4004a by being inserted into the connection holes 4004c.

As shown in FIG. 28, the reclining device 4005 includes a known lock mechanism, and can switch the state of the back frame 4010 between a locked state where the back frame 4010 is fixed with respect to the cushion frame 4020 and an unlocked state where the back frame 4010 is rotatable with respect to the cushion frame 4020.

As shown in FIGS. 28 to 30, the tilt link device 4006 is a device that is attached between the cushion frame 4020 and a pan frame 4030, that is rotatably attached to side surfaces of side frames 4021, and that rotationally moves in the up to down direction to raise and lower the pan frame 4030. The tilt link device 4006 mainly includes tilt brackets 4007, tilt links 4008, and a tilt motor 4009.

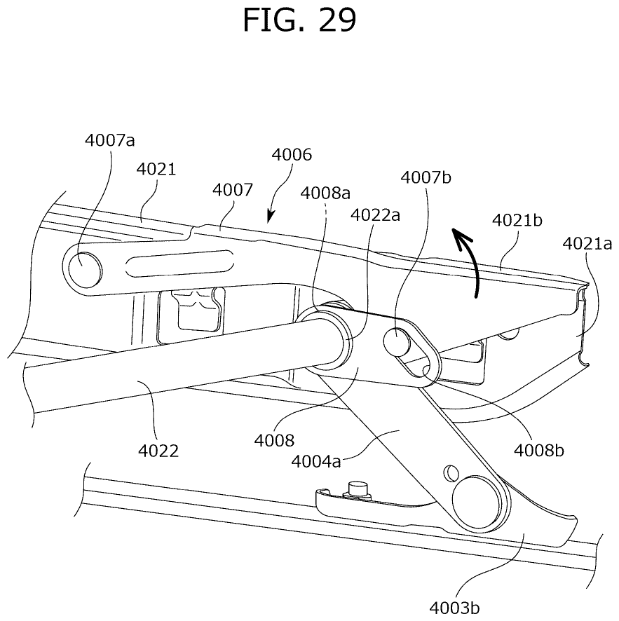

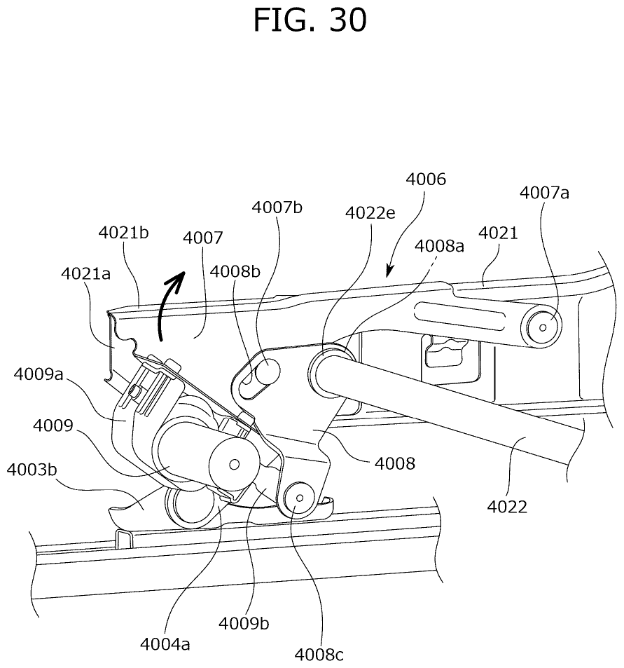

As shown in FIGS. 29 and 30, the tilt brackets 4007 are support brackets that are long in the seat front to rear direction, and are rotatably attached to the side surfaces of the side frames 4021.

In addition, the tilt motor 4009 is attached to a lower surface of the right tilt bracket 4007.

Rear portions of the tilt brackets 4007 are attached to the side surfaces of the side frames 4021 via rotation pins 4007a, and front portions of the tilt brackets 4007 are attached to the tilt links 4008 via link pins 4007b.

As shown in FIGS. 29 and 30, the tilt links 4008 are link members having a plate shape, and are attached to the front connecting frame 4022. The tilt links 4008 rotationally move the tilt brackets 4007 in the up to down direction with respect to the side frames 4021.

Shaft holes 4008a for inserting the front connecting frame 4022 are formed at rear portions of the tilt links 4008, and pin connection holes 4008b that slidably engage with the link pins 4007b are formed at front portions of the tilt links 4008.

In addition, a motor connecting portion 4008c connected to a link movable portion 4009b to be described later is formed at a lower portion of the right tilt link 4008.

The shaft holes 4008a have an uneven shape in a circumferential direction, and the front connecting frame 4022 includes uneven portions (not shown) conforming to the shape of the shaft holes 4008a. The shaft holes 4008a and the uneven portions formed on the front connecting frame 4022 are fitted to each other, so that the front connecting frame 4022 and the tilt links 4008 rotate integrally.

As shown in FIG. 30, the tilt motor 4009 is a drive source that raises and lowers the pan frame 4030, and includes a motor fixing portion 4009a attached to the tilt bracket 4007, and the link movable portion 4009b connected to the motor connecting portion 4008c.

An operation in which the pan frame 4030 is moved from a normal position to a raised position by the tilt link device 4006 will be described.

In the right tilt link 4008, the motor connecting portion 4008c moves forward as the link movable portion 4009b moves forward in conjunction with the drive operation of the tilt motor 4009. Further, the tilt link 4008 rotates upward about the front connecting frame 4022 as a central axis.

As the tilt link 4008 rotationally operates upward, the tilt bracket 4007 connected via the link pin 4007b rotates upward about the rotation pin 4007a as a central axis.

In addition, the front connecting frame 4022 rotates in conjunction with the upward rotational operation of the right tilt link 4008, so that the left tilt link 4008 rotates upward. Further, as the tilt link 4008 rotationally operates upward, the tilt bracket 4007 connected via the link pin 4007b rotates upward about the rotation pin 4007a as a central axis.

As a result, the pan frame 4030 is rotationally movable from the normal position to the raised position.

As shown in FIG. 28, a seat frame Sa5 serving as a skeleton of the conveyance seat S5 includes a back frame 4010 forming a skeleton of the seat back 4001, and a cushion frame 4020 forming a skeleton of the seat cushion 4002.

As shown in FIG. 28, the back frame 4010 is made of a substantially rectangular frame-shaped body, and mainly includes back side frames 4011 disposed on the right and left sides; an upper frame 4012 having an inverted U shape and connecting upper end portions of the back side frames 4011; a lower frame 4013 having a plate shape and connecting lower end portions of the back side frames 4011; wire members 4014 each hooked onto the upper frame 4012 and extending in the up to down direction; and a pressure receiving panel 4015 connecting lower end portions of the wire members 4014 and the lower frame 4013.

The back side frames 4011 are sheet metal members extending in the up to down direction and having a substantially C-shaped horizontal cross section, and lower end portions of the back side frames 4011 are connected to rear end portions of the side frames 4021 via the reclining device 4005.

As shown in FIG. 28, the cushion frame 4020 is made of a substantially rectangular frame-shaped body, and mainly includes the side frames 4021 disposed on the right and left sides and extending in the seat front to rear direction; the front connecting frame 4022 connecting front portions of the side frames 4021; a rear connecting frame 4023 connecting rear portions of the side frames 4021; washers 4024 that rotatably hold the first height links 4004a; the pan frame 4030 having a plate shape and installed on front end portions of the side frames 4021 in a bridging manner; a pressure receiving member 4040 hung on the rear connecting frame 4023 and disposed between the side frames 4021.

As shown in FIG. 28, each of the side frames 4021 is a plate-shaped frame that is long in the seat front to rear direction, and includes a through-hole 4021a formed in a side surface of the side frame 4021, and an upper end flange portion 4021b and a lower end flange portion 4021c that bend and protrude outward from an upper end portion and a lower end portion of the side surface of the side frame 4021 in the seat width direction, respectively.

Incidentally, the reclining device 4005 is attached to the rear end portions of the side frames 4021.

As shown in FIG. 28, the front connecting frame 4022 is a pipe-shaped frame, and connects the right and left side frames 4021 and connects the right and left first height links 4004a and the right and left tilt links 4008. The right and left first height links 4004a and the right and left tilt links 4008 are attached to the front connecting frame 4022 at predetermined distances from each other in the seat width direction.

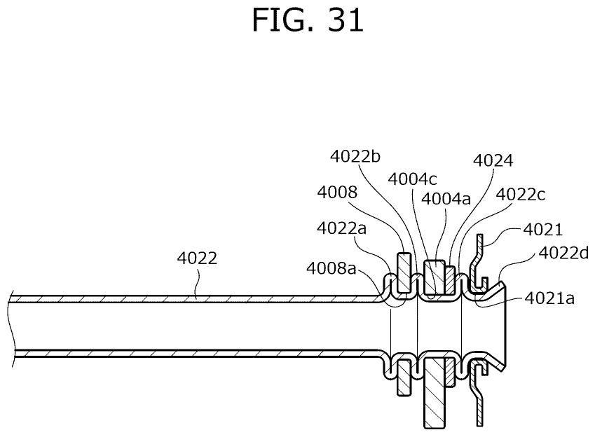

As shown in FIG. 31, a plurality of projection portions 4022a, 4022b, and 4022c are formed on a left outer peripheral surface of the front connecting frame 4022 at predetermined distances from each other in an extending direction of the front connecting frame 4022. In addition, an expanded portion 4022d that is increased in diameter as the expanded portion 4022d extends outward in the extending direction is formed at an extension end portion of the front connecting frame 4022.

In more detail, on the left side of the front connecting frame 4022, the first projection portion 4022a, the second projection portion 4022b formed outside the first projection portion 4022a, the third projection portion 4022c formed outside the second projection portion 4022b, and the expanded portion 4022d formed outside the third projection portion 4022c are provided in the extending direction of the front connecting frame 4022.

The first projection portion 4022a and the second projection portion 4022b sandwich the tilt link 4008 therebetween, and the second projection portion 4022b and the third projection portion 4022c sandwich the first height link 4004a therebetween via the washer 4024. In addition, the third projection portion 4022c and the expanded portion 4022d support the side frame 4021.

In such a manner, the first height link 4004a and the tilt link 4008 are attached to the front connecting frame 4022 at a predetermined distance from each other in the seat width direction by being sandwiched between the projection portions 4022a to 4022c.

Incidentally, the above-described term “being sandwiched” also includes a state where the plurality of projection portions 4022a to 4022c cover the first height link 4004a and the tilt link 4008 with slight gaps between the first height link 4004a, the tilt link 4008, and each of the projection portions, in addition to a state where the plurality of projection portions 4022a to 4022c are in contact with the first height link 4004a and the tilt link 4008.

The plurality of projection portions 4022a to 4022c on the left side of the front connecting frame 4022 are formed by bulge processing. Bulge processing is performed in a state where the front connecting frame 4022 is inserted into the connection hole 4004c of the first height link 4004a and the shaft hole 4008a of the tilt link 4008, so that the front connecting frame 4022 is bulged and the plurality of projection portions 4022a to 4022c are formed. Further, the first height link 4004a and the tilt link 4008 are sandwiched between the plurality of projection portions 4022a to 4022c that are formed.

Here, the front connecting frame 4022 is deformed by bulge processing to follow the uneven shape of the shaft hole 4008a of the tilt link 4008. Accordingly, a portion of the front connecting frame 4022 between the first projection portion 4022a and the second projection portion 4022b is fitted to the uneven shape of the shaft hole 4008a, and the front connecting frame 4022 and the tilt link 4008 are integrated in a direction around the axis of the front connecting frame 4022.

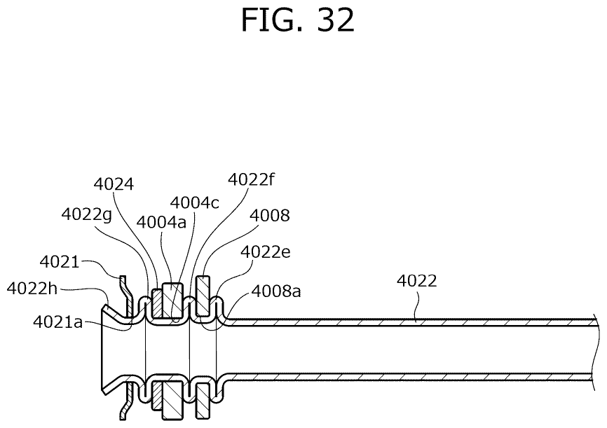

Incidentally, since a plurality of projection portions 4022e to 4022g on the right side of the front connecting frame 4022 have the same configuration as those on the left side as shown in FIG. 32, the description thereof will be omitted.

In addition, the expanded portion 4022d of the front connecting frame 4022 is formed by flare processing. Flare processing is performed in a state where the front connecting frame 4022 is inserted into the through-hole 4021a of the side frame 4021, so that a bulged portion of the front connecting frame 4022 becomes the expanded portion 4022d, and the side frame 4021 can be held.

Incidentally, since the plurality of projection portions 4022e to 4022g and an expanded portion 4022h on the right side of the front connecting frame 4022 have the same configuration as those on the left side as shown in FIG. 32, the description thereof will be omitted.

As shown in FIG. 28, the rear connecting frame 4023 is a pipe-shaped frame, and connects the right and left side frames 4021 and connects the right and left second height links 4004b.

As shown in FIG. 28, the pan frame 4030 is a plate-shaped frame installed on the upper surfaces of the right and left side frames 4021 in a bridging manner and supporting the thighs of the seated occupant. Side portions of the pan frame 4030 in the seat width direction are placed and attached to the upper surfaces of the side frames 4021.

The pressure receiving member 4040 is formed of a resin member. As shown in FIG. 28, the pressure receiving member 4040 has a shape that is recessed downward, and the pressure receiving member 4040 is configured to support the buttocks of the occupant seated in the conveyance seat S5 in its entirety.

As shown in FIG. 28, the pressure receiving member 4040 includes a bottom portion 4041 provided at a central portion of the pressure receiving member 4040 in the seat width direction at a position lower in height than each of the side frames 4021; side inclined portions 4042 that are inclined upward from both side portions of the bottom portion 4041 toward the respective side frames 4021; and a fixing portion 4043 attached to the vehicle body floor at a position behind the front connecting frame 4022.

The bottom portion 4041 includes elastic springs 4041a extending in the seat front to rear direction and supporting the buttocks of the seated occupant from below. Front end portions of the elastic springs 4041a are hooked onto the fixing portion 4043, and rear end portions are hooked onto the rear connecting frame 4023.

In such a manner, the pressure receiving member 4040 can support the seated occupant over a wider area via the pad material 4002a compared to when the pressure receiving member 4040 is formed in a flat plate shape, so that seating comfort when seated can be improved.

In addition, as shown in FIG. 28, a front end of the pressure receiving member 4040 may be located behind a rear end of the front connecting frame 4022. In more detail, the plurality of projection portions 4022a to 4022c and 4022e to 4022g of the front connecting frame 4022 may be located closer to the seat front side than the pressure receiving member 4040. Consequently, interference between each of the first height link 4004a and the tilt link 4008 and the pressure receiving member 4040 can be suppressed.

In addition, as shown in FIG. 28, outer ends of the pressure receiving member 4040 in the seat width direction may be located inside the extension end portions of the front connecting frame 4022. In more detail, the plurality of projection portions 4022a to 4022c and 4022e to 4022g of the front connecting frame 4022 may be located outside the pressure receiving member 4040 in the seat width direction. Consequently, interference between each of the first height link 4004a and the tilt link 4008 and the pressure receiving member 4040 can be suppressed.

### <<Others>>

In the embodiment, as shown in FIG. 28, the plurality of projection portions 4022a to 4022c and 4022e to 4022g formed on the front connecting frame 4022 are configured to sandwich the first height link 4004a and the tilt link 4008 therebetween; however, the present invention is not limited thereto, and the configuration can be changed.

For example, the plurality of projection portions 4022a to 4022c and 4022e to 4022g formed on the front connecting frame 4022 may be configured to sandwich a drive member of a seat drive device other than the height link device 4004 and the tilt link device 4006.

In addition, for example, the rear connecting frame 4023 may include a plurality of projection portions. In addition, when the rear connecting frame 4023 sandwiches the height link device 4004, the plurality of projection portions formed on the rear connecting frame 4023 may be configured to sandwich a drive member of a seat drive device other than the height link device 4004.

In addition, for example, a plurality of projection portions formed on the lower frame 4013 having a pipe shape may be configured to sandwich a drive member of a seat drive device.

In the embodiment, as shown in FIGS. 31 and 32, the first height link 4004a is configured to be sandwiched between the plurality of projection portions via the washer 4024, but may be configured to be sandwiched without using the washer 4024.

### <<Additional Notes>>

A conveyance seat S5 may include a seat frame serving as a skeleton; a height link device that raisably and lowerably connects the seat frame to a vehicle body floor; and a tilt link device that tiltably connects a part of the seat frame to the vehicle body floor. The seat frame may include side frames disposed on right and left sides in a seat width direction, a front connecting frame having a pipe shape and connecting front portions of the right and left side frames, and a pan frame having a plate shape and connecting front end portions of the right and left side frames. The height link device may include a height link having a plate shape, provided between the seat frame and the vehicle body floor, and supporting the seat frame. The tilt link device may include a tilt bracket provided on the side frame and supporting the pan frame, and a tilt link having a plate shape and rotationally moving the tilt bracket in an up to down direction with respect to the side frame. The height link and the tilt link may be attached to the front connecting frame at a predetermined distance from each other in the seat width direction. A plurality of projection portions may be formed on an outer peripheral surface of the front connecting frame at predetermined distances from each other in an extending direction of the front connecting frame. The plurality of projection portions may protrude in a direction orthogonal to the extending direction, and may sandwich the height link and the tilt link between the plurality of projection portions.

With the above-described configuration, the conveyance seat in which a plurality of the link members can be fixed with a simple configuration can be realized.

In more detail, by sandwiching the plurality of link members between the plurality of projection portions formed on the outer peripheral surface of the front connecting frame, each of the plurality of link members can be fixed, so that there is no need for providing a separate fixing member, and the number of components can be reduced.

In this case, the plurality of projection portions may be formed by bulge processing.

With the above-described configuration, the plurality of link members can be fixed by the shape of the front connecting frame without providing a separate member on the front connecting frame.

In this case, the plurality of projection portions may include a first projection portion, a second projection portion formed outside the first projection portion in the extending direction, and a third projection portion formed outside the second projection portion in the extending direction. The first projection portion and the second projection portion may sandwich the tilt link between the first projection portion and the second projection portion, and the second projection portion and the third projection portion may sandwich the height link between the second projection portion and the third projection portion.

With the above-described configuration, the plurality of link members can be positioned with higher accuracy.

In this case, the front connecting frame may include an expanded portion formed outside the third projection portion in the extending direction. The expanded portion may be increased in diameter as the expanded portion extends outward in the extending direction. The third projection portion and the expanded portion may hold the side frame.

With the above-described configuration, the falling off of the side frame from the front connecting frame can be suppressed without providing a separate fixing member.

In this case, the expanded portion may be formed by flare processing.

With the above-described configuration, the side frame can be held by the shape of the front connecting frame without providing a separate member on the front connecting frame.

In this case, the second projection portion and the third projection portion may sandwich the height link between the second projection portion and the third projection portion via a washer.

With the above-described configuration, the height link is more smoothly rotatable with respect to the front connecting frame.

In this case, the seat frame may further include a pressure receiving member that supports buttocks of a seated occupant. The plurality of projection portions may be located closer to a seat front side than the pressure receiving member.

With the above-described configuration, interference between the plurality of link members and the pressure receiving member can be suppressed.

In this case, the seat frame may further include a pressure receiving member that supports buttocks of a seated occupant. The plurality of projection portions may be located outside the pressure receiving member in the seat width direction.

With the above-described configuration, interference between the plurality of link members and the pressure receiving member can be suppressed.

In the first to fifth embodiments, the conveyance seats used in automobiles have been described as specific examples; however, the present invention is not particularly limited thereto, and the conveyance seats can be used as conveyance seats for airplanes, ships, and the like in addition to conveyance seats for trains, buses, and the like.

In the first to fifth embodiments, the conveyance seats according to the present invention have been mainly described.

However, the embodiments are merely examples provided to facilitate understanding of the present invention, and do not limit the present invention. The present invention can be modified and improved without departing from the concept of the present invention, and it goes without saying that the present invention includes its equivalents.

### REFERENCE SIGNS LIST

### First Embodiment

S1: Conveyance seat
Sa1: Seat frame
1: Seat back
1a, 2a: Pad material
1b, 2b: Skin material
2: Seat cushion
3: Rail device
3a: Lower rail
3b: Upper rail
3c: Rail operating lever
4: Height link device
4a: First link
4b: Second link
5: Reclining device
5a: Reclining body
5b: Rotating shaft
5c: Spiral spring
10: Back frame
11: Back side frame (side frame)
12: Upper frame (connecting frame)
13: Lower frame
14: Member frame
20, 220, 320, 420, 520: Cushion frame
21, 221, 321, 421, 521: Side frame (cushion side frame)
21a: Frame body portion
21b: Upper end flange portion (flange portion)
21c: Lower end flange portion
21d: Skin hooking portion
21e: Attachment hole
22: Front connecting frame
23: Rear connecting frame
24: Elastic spring (elastic member)
30, 230, 330, 430, 530: Pan frame (connecting frame)
31, 531: Frame body portion
32: Frame front wall portion
32a, 33a: Bent portion
33: Frame side wall portion
34: First reinforcement recess (reinforcement portion)
35: Second reinforcement recess (reinforcement portion)
36: Skin hooking portion (hooking portion)
37: Spring hooking portion (hooking portion)
38: Attachment hole
39: Attachment bolt (attaching member)
39A: First attachment bolt (first attaching member)
39B: Second attachment bolt (second attaching member)
40, 140, 240, 340, 440: Engagement protrusion (engaging portion)
41, 241: Front wall portion
42, 242: Rear wall portion
43, 243: Side wall portion
44, 244: Upper wall portion
441: Cut-and-raised portion
442: Folded-back portion
50, 150, 250: Engagement recess (engaged portion)
51, 251: Front wall portion
52, 252: Rear wall portion
53, 253: Side wall portion
54, 254: Upper wall portion
350, 450: Engagement hole (engaged portion)
540: Engagement cut portion (engaging portion)
541: Bottom wall portion
542, 543: Side wall portion
550: Engagement bent portion (engaged portion)
560: Reinforcement bead

### Second Embodiment

S2: Conveyance seat
Sa2: Seat frame
1001: Seat back
1001a: Pad material
1001b: Skin material
1002: Seat cushion
1002a: Pad material
1002b: Skin material
1002c: Clearance portion
1003: Rail device
1003a: Lower rail
1003b: Upper rail
1003c: Rail operating lever
1004: Height link device
1004a: First link
1004b: Second link (drive link)
1004c: Height operating lever
1005: Reclining device
1005a: Reclining body
1005b: Rotating shaft
1005c: Spiral spring
1005ca: One end portion
1005cb: The other end portion
1005d: Spring latching bracket
1005e: Reclining operating lever
1010: Back frame
1011: Back side frame (first frame member)
1012: Upper frame
1013: Lower frame
1020: Cushion frame
1021: Cushion side frame (first frame member)
1021a: Body wall portion
1021b: Upper end flange
1021c: Lower end flange
1021d: First surface
1021e: First facing surface
1021f: First rising portion
1021g: Third rising portion
1021h: Insertion hole
1022: Front connecting frame
1023: Rear connecting frame
1024: Elastic spring
1030: Pan frame
1030a: Spring hooking portion
1060: Connecting bracket
1060d: Second surface
1060e: Second facing surface
1060f: Second rising portion
1061: Spring latching portion
1062: Cutout portion
1070: Screw (fastening member)
1071: Screw head portion
1072: Recessed portion
1073: Thread portion
1074: Space portion
1075: Screw head space portion
1080: Drive device
1081: Connection member
1121: Cushion side frame
1121d: First surface
1121e: First facing surface
1121f: First rising portion
1160: Connecting bracket (second frame member)
1160d: Second surface
1160e: Second facing surface
1160f: Second rising portion
1170: Rivet (fastening member)
1171: Rivet head portion
1172: Rivet shaft portion
P1 to P13: Fastening position

### Third Embodiment

S3: Conveyance seat (conveyance seat)
Sa3: Seat frame
SP: Gap
HR: Headrest
2001: Seat back
2001a: Skin material
2001b: Pad material
2002: Seat cushion
2002a: Skin material
2002b: Pad material
2003: Rail device
2003a: Lower rail
2003b: Upper rail
2005: Reclining device
2010: Back frame
2011: Back side frame
2011a: Rear wall portion
2012: Upper frame
2013: Lower frame
2014: Headrest guide
2015: Headrest frame
2016: Headrest stay
2020: Cushion frame
2021: Side frame (side frame)
2022: Front connecting frame (front connection member)
2023: Rear connecting frame (rear connection member)
2030: Pan frame (pan frame)
2040: Pressure receiving member
2041: Bottom portion
2041a: Front inclined portion
2041b: Front end
2042: Side inclined portion
2042a: Front end
2043: Bolt
2050: ECU
2051: Harness member

### Fourth Embodiment

S4: Conveyance seat (conveyance seat)
Sa4: Seat frame
HR: Headrest
3001: Seat back
3001a: Skin material
3001b: Pad material
3002: Seat cushion
3002a: Skin material
3002b: Pad material
3003: Rail device
3003a: Lower rail
3003b: Upper rail
3005: Reclining device
3010: Back frame
3011: Back side frame (side frame)
3011a: Rear wall portion
3012: Upper frame (connection member)
3013: Lower frame (connection member)
3014: Headrest guide
3015: Headrest frame
3016: Headrest stay
3020: Cushion frame
3021: Side frame (side frame)
3022: Front connecting frame (connection member)
3023: Rear connecting frame (connection member)
3030: Pan frame (pan frame)
3040: Pressure receiving member
3041: Body portion
3042: Side portion
3043, 3044: Protruding portion
3045: Extending portion
3045a: First extending portion
3045b: Second extending portion
3046: Elastic member
3046a: First elastic member
3046b: Second elastic member
3047: Rivet

### Fifth Embodiment

S5: Conveyance seat
Sa5: Seat frame
4001: Seat back
4001a: Pad material
4001b: Skin material
4002: Seat cushion
4002a: Pad material
4002b: Skin material
4003: Rail device
4003a: Lower rail
4003b: Upper rail
4004: Height link device
4004a: First height link
4004b: Second height link
4004c: Connection hole
4005: Reclining device
4006: Tilt link device
4007: Tilt bracket
4007a: Rotation pin
4007b: Link pin
4008: Tilt link
4008a: Shaft hole
4008b: Pin connection hole
4008c: Motor connecting portion
4009: Tilt motor
4009a: Motor fixing portion
4009b: Link movable portion
4010: Back frame
4011: Back side frame
4012: Upper frame
4013: Lower frame
4014: Wire member
4015: Pressure receiving panel
4020: Cushion frame
4021: Side frame
4021a: Through-hole
4021b: Upper end flange portion
4021c: Lower end flange portion
4022: Front connecting frame
4022a, 4022e: First projection portion
4022b, 4022f: Second projection portion
4022c, 4022g: Third projection portion
4022d, 4022h: Expanded portion
4023: Rear connecting frame
4024: Washer
4030: Pan frame
4040: Pressure receiving member
4041: Bottom portion
4041a: Elastic spring
4042: Side inclined portion
4043: Fixing portion

1. A conveyance seat, comprising:
a seat frame serving as a skeleton,
wherein the seat frame includes side frames disposed on right and left sides in a seat width direction, and a connecting frame connecting the right and left side frames,
the side frames include engaging portions that engage with respective engaged portions provided in the connecting frame, to position the connecting frame,
one of the engaging portions and the engaged portions is formed to protrude toward the other of the engaging portions and the engaged portions in a facing direction in which the side frames and the connecting frame face each other, and
the other engages with the one by coming into contact with the one in an intersecting direction intersecting with the facing direction.

2. The conveyance seat according to claim 1,
wherein the one is an engagement protrusion protruding toward the other side in the facing direction, and
the other is an engagement hole that engages with the engagement protrusion, or is an engagement recess recessed opposite to one side in the facing direction.

3. The conveyance seat according to claim 1,
wherein the engaging portions come into contact with the respective engaged portions in the facing direction and the intersecting direction to position the connecting frame in the facing direction and the intersecting direction.

4. The conveyance seat according to claim 1,
wherein the engaging portions are formed at respective outer end portions of the side frames in the seat width direction,
the engaged portions are formed at respective outer end portions of the connecting frame in the seat width direction, and
the engaging portions and the engaged portions are exposed to an outside of the seat frame in the seat width direction in the seat frame.

5. The conveyance seat according to claim 1,
wherein the connecting frame is formed from a plate-shaped frame,
the connecting frame includes a reinforcement portion formed as a protrusion or a recess on a surface of the connecting frame and extending in the seat width direction, and
the engaged portions are formed on the surface of the connecting frame at positions avoiding the reinforcement portion.

6. The conveyance seat according to claim 5,
wherein the side frames are side frames extending in a seat front to rear direction,
the connecting frame is a pan frame installed on front portions of the right and left side frames in a bridging manner,
the reinforcement portion is formed as a reinforcement recess having a recessed shape,
a hooking portion for hooking a seat component of the conveyance seat is formed on an upper surface of a portion of the pan frame at which the reinforcement recess is formed, and
the engaged portions are formed on the respective right and left sides in the seat width direction, and are disposed at positions where the engaged portions interpose the reinforcement recess between the engaged portions in the seat width direction.

7. The conveyance seat according to claim 1,
wherein the side frames are side frames extending in a seat front to rear direction,
the connecting frame is a pan frame installed on front portions of the right and left side frames in a bridging manner,
the side frames include respective flange portions formed at upper end portions of the side frames and protruding from respective body portions of the side frames to one side in the seat width direction, and
the engaging portions are formed on upper surfaces of the respective flange portions, and engage with the respective engaged portions formed on a bottom surface of the pan frame in a state where the upper surfaces of the flange portions and the bottom surface of the pan frame are overlapped.

8. The conveyance seat according to claim 1,
wherein the connecting frame is connected to the side frames by fastening a plurality of attaching members on surfaces where the connecting frame and the side frames face each other, and
the engaging portions and the engaged portions are each disposed between a first attaching member and a second attaching member in a seat front to rear direction.

9. The conveyance seat according to claim 8,
wherein each of the engaging portions and the engaged portions extends in the seat width direction, extends further outward in the seat width direction than the first attaching member and the second attaching member, and extends further inward in the seat width direction than the first attaching member and the second attaching member.

10. The conveyance seat according to claim 1,
wherein the side frames are side frames extending in a seat front to rear direction,
the connecting frame is a pan frame installed on front portions of the right and left side frames in a bridging manner,
the pan frame includes a frame body portion that is long in the seat width direction, and right and left frame side wall portions protruding downward from both respective end portions of the frame body portion in the seat width direction, and
the frame side wall portions and the engaged portions are formed in the pan frame at different positions in the seat front to rear direction.
